(19) United States
(12) Patent Application Publication
(10) Pub. No.: US 2023/0368226 A1
(43) Pub. Date: Nov. 16, 2023

(54) SYSTEMS AND METHODS FOR IMPROVED USER EXPERIENCE PARTICIPANT SELECTION

(71) Applicant: Userzoom Technologies, Inc., Dover, DE (US)

(72) Inventors: Xavier Mestres, Barcelona (ES); Laura Bernabe Miguel, Denver, CO (US); Jordi Ibañez, Barcelona (ES)

(21) Appl. No.: 18/302,166

(22) Filed: Apr. 18, 2023

Related U.S. Application Data
(60) Provisional application No. 63/333,058, filed on Apr. 20, 2022.

(51) Int. Cl. G06Q 30/0203; H04L 67/30

(52) U.S. Cl. CPC G06Q 30/0203; H04L 67/30

(57) ABSTRACT

Systems and methods for selecting participants for a user experience study are provided. In some embodiments the systems and methods first receive at least three features for each participant profile. The participant profile is scored by quantile-based discretization. Next the participants are grouped into clusters using an unsupervised machine learning (ML) clustering algorithm(s) for each participant profile. The clusters are ranked using a number of models. These models are a function of geography and study type. The participant profile is assigned to a single cluster for each model. Participants are sampled from the clusters by their ranking.

### CROSS REFERENCED TO RELATED APPLICATION

This application claims the benefit and priority of U.S. Provisional Application No. 63/333,058 (Attorney Docket UZM-2201-P), filed on Apr. 20, 2022, entitled “SYSTEMS AND METHODS FOR IMPROVED USER EXPERIENCE PARTICIPANT SELECTION”, the contents of which is incorporated herein in its entirety by this reference.

### BACKGROUND

The present invention relates to systems and methods for the AI assisted analysis of user experience studies that allow for insight generation for the user experience of a website. Generally, this type of testing is referred to as “User Experience” or merely “UX” testing.

The Internet provides new opportunities for business entities to reach customers via web sites that promote and describe their products or services. Often, the appeal of a web site and its ease of use may affect a potential buyer's decision to purchase the product/service.

Especially as user experiences continue to improve and competition online becomes increasingly aggressive, the ease of use by a particular retailer's website may have a material impact upon sales performance. Unlike a physical shopping experience, there is minimal hurdles to a user going to a competitor for a similar service or good. Thus, in addition to traditional motivators (e.g., competitive pricing, return policies, brand reputation, etc.) the ease of a website to navigate is of paramount importance to a successful online presence.

As such, assessing the appeal, user friendliness, and effectiveness of a web site is of substantial value to marketing managers, web site designers and user experience specialists; however, this information is typically difficult to obtain. Focus groups are sometimes used to achieve this goal but the process is long, expensive and not reliable, in part, due to the size and demographics of the focus group that may not be representative of the target customer base.

In more recent years advances have been made in the automation and implementation of mass online surveys for collecting user feedback information. Typically these systems include survey questions, or potentially a task on a website followed by feedback requests. While such systems are useful in collecting some information regarding user experiences, the studies often suffer from biases in responses, and limited types of feedback collected.

In order to overcome these limitations, systems and methods have been developed to provide more immersive user experience testing which utilize AI analytics, audio and video recording, and improved interfaces. These systems and methods have revolutionized user experience testing, but still fundamentally rely upon the ability to recruit sufficient numbers of qualified and interested participants.

Sourcing capable participants is always a challenge, and becomes particularly difficult when very large studies are performed, or many studies are operating in parallel. Traditionally, companies would solicit individuals to join focus groups. Such methods were generally effective in collecting small groups of willing participants, but are extremely resource intensive, and fail to scale in any appreciable manner. With the invention of the internet, more individuals could be solicited in a much more cost effective manner. These populations are aggregated by survey provider groups, and can serve as a source for willing participants. However, selection of which participants to engage is still a significant problem—too often the participants are of inferior quality given the study requirements, or the selection process scales badly due to the criteria for the participants.

It is therefore apparent that an urgent need exists for advancements in the selection of participants for user experience studies. Such systems and methods allow for participant selection that is better tailored to the study requirements.

### SUMMARY

To achieve the foregoing and in accordance with the present invention, systems and methods for participant selection for a user experience studies is provided. These systems and methods are capable of delivering qualified and scalable numbers of participants for large, complex and multiple parallel user experience studies in a manner not available previously.

The methods and systems for selecting participants for a user experience study first receives at least three features for each participant profile. The participant profile is scored by quantile-based discretization. Next the participants are grouped into clusters using an unsupervised machine learning (ML) clustering algorithm(s) for each participant profile. The clusters are ranked using a number of models. These models are a function of geography and study type. The participant profile is assigned to a single cluster for each model. Participants are sampled from the clusters by their ranking.

In some embodiments, the scores include: 1) time since last participation, 2) total number of participations of the given participant profile, 3) time response score, 4) quality response score, 5) burnout ratio and 6) exclusion variable. Each cluster has a single score for each model. A numeric weight is received for each of the scores. The sampling proportion from each cluster is correlated with the cluster score. Further, sampling includes ponderation from lower ranked clusters.

For new participant profiles, they may be clustered using supervised modeling. Before even being considered for clustering and selection, the system may ask the participant question(s) to determine missing feature(s) in their profile. Lastly, the system may intentionally send an invitation to the selected participants which are a better fit to engage in a user experience study.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1A is a first logical diagram of an example system for user experience studies, in accordance with some embodiment;

FIG. 1B is a second logical diagram of an example system for user experience studies, in accordance with some embodiment;

FIG. 1C is a third logical diagram of an example system for user experience studies, in accordance with some embodiment;

FIG. 2 is an example logical diagram of the user experience testing system, in accordance with some embodiment;

FIG. 3A-3C are flow diagrams illustrating an exemplary process of interfacing with potential candidates and performing user experience testing according to an embodiment of the present invention;

FIG. 4 is a simplified block diagram of a data processing unit configured to enable a participant to access a web site and track participant's interaction with the web site according to an embodiment of the present invention;

FIG. 5 is an example logical diagram of a participant management architecture, in accordance with some embodiment;

FIG. 6 is a logical diagram of the participant management system, in accordance with some embodiment;

FIG. 7 is a logical diagram of the selection server, in accordance with some embodiment;

FIG. 8 is a logical diagram of a participant scoring module, in accordance with some embodiment;

FIG. 9 is a logical diagram of a participant offer management module, in accordance with some embodiment;

FIG. 10 is a flow diagram for an example process of participant selection, in accordance with some embodiment;

FIG. 11 is a flow diagram for the example process of participant selection initialization, in accordance with some embodiment;

FIG. 12 is a flow diagram for the example process of screening question generation, in accordance with some embodiment;

FIG. 13 is a flow diagram for the example process of participant selection, in accordance with some embodiment;

FIG. 14 is a flow diagram for the example process of participant fielding, in accordance with some embodiment;

FIG. 15 is a flow diagram for the example process of participant monitoring, in accordance with some embodiment;

FIG. 16 is a flow diagram for the example process of model generation and training, in accordance with some embodiment;

FIG. 17 is a flow diagram for the example process of participant sampling, in accordance with some embodiment;

FIG. 18 is a flow diagram for the example process of profile scoring, in accordance with some embodiment; and

FIG. 19 is an example illustration for a clustering matrix, in accordance with some embodiment.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to the selection of participants for user experience testing and subsequent insight generation. While such systems and methods may be utilized with any user experience environment, embodiments described in greater detail herein are directed to providing participants for user experience studies in an online/webpage environment. Some descriptions of the present systems and methods will also focus nearly exclusively upon the user experience within a retailer's website. This is intentional in order to provide a clear use case and brevity to the disclosure, however it should be noted that the present systems and methods apply equally well to any situation where a user experience in an online platform is being studied. As such, the focus herein on a retail setting is in no way intended to artificially limit the scope of this disclosure.

In the following it is understood that the term ‘usability’ refers to a metric scoring value for judging the ease of use of a target web site. A ‘client’ refers to a sponsor who initiates and/or finances the user experience study. The client may be, for example, a marketing manager who seeks to test the user experience of a commercial web site for marketing (selling or advertising) certain products or services. ‘ Participants’ may be a selected group of people who participate in the user experience study and may be screened based on a predetermined set of questions. ‘UX researcher’ or ‘UX designer’ refers to an individual generating or collecting information on user experience via a study. A Project manager′ or ‘Marketing Manager’ are generally client employees tasked with determining the user experience of a product or website. These individuals may author a study directly, or leverage a UX researcher to author a user experience study. ‘Remote user experience testing’ or ‘remote user experience study’ refers to testing or study in accordance with which participants (referred to use their computers, mobile devices or otherwise) access a target web site in order to provide feedback about the web site's ease of use, connection speed, and the level of satisfaction the participant experiences in using the web site. Unmoderated user experience testing′ refers to communication with test participants without a moderator, e.g., a software, hardware, or a combined software/hardware system can automatically gather the participants' feedback and records their responses. The system can test a target web site by asking participants to view the web site, perform test tasks, and answer questions associated with the tasks.

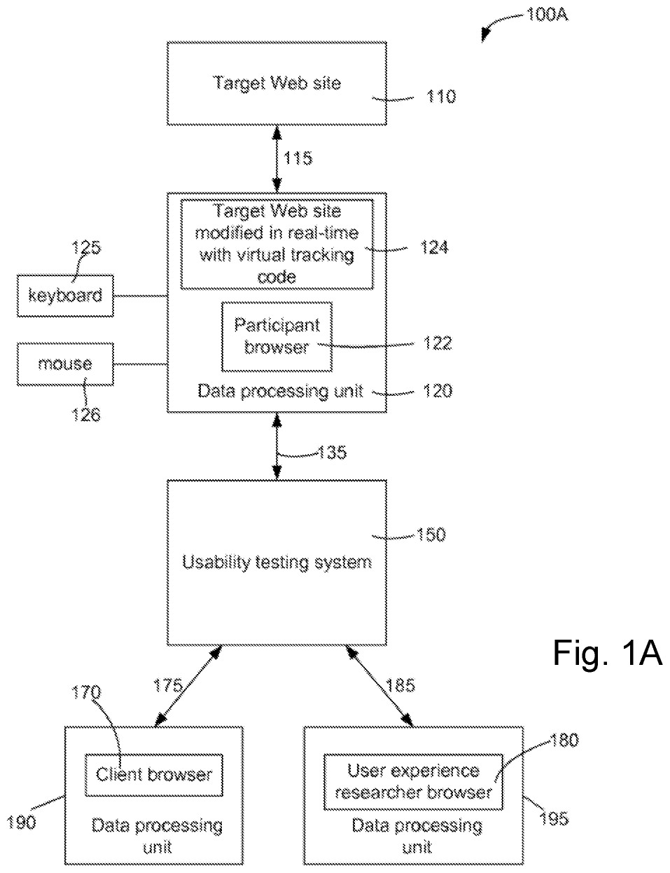

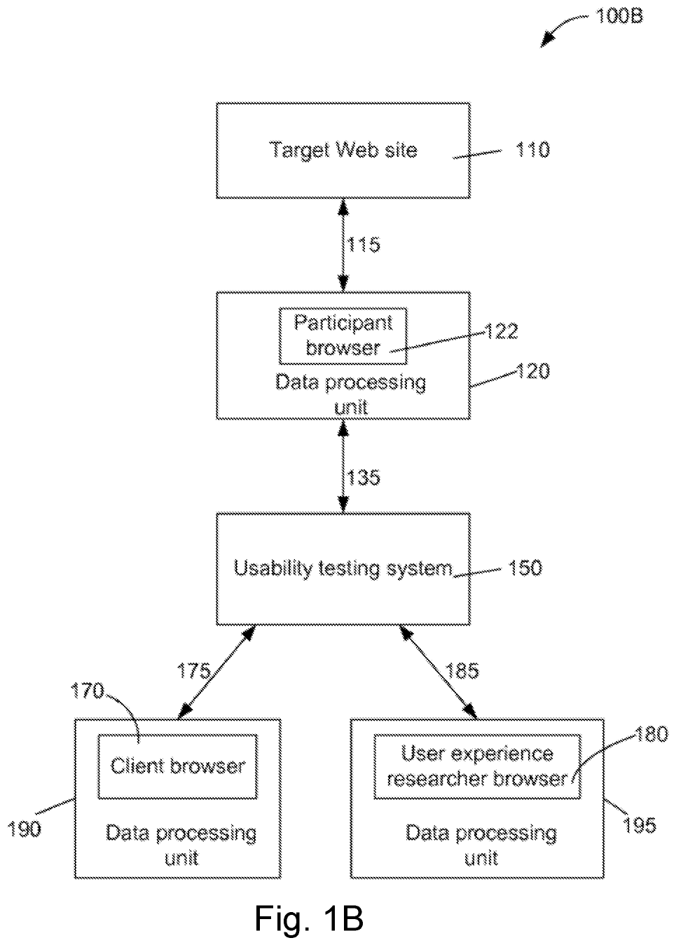

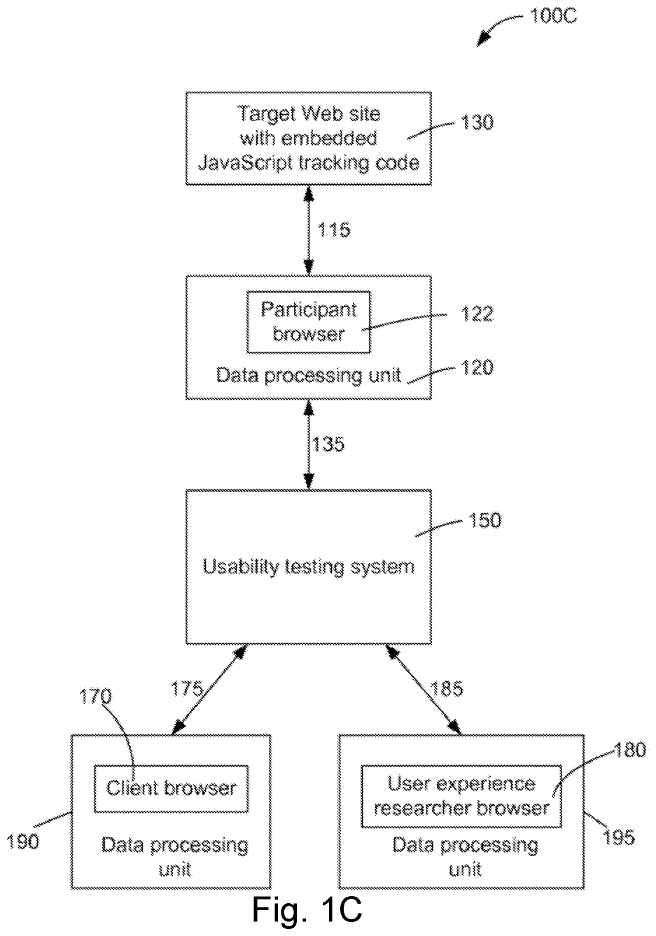

To facilitate the discussion, FIG. 1A is a simplified block diagram of a user testing platform 100A according to an embodiment. Platform 100A is adapted to test a target web site 110. Platform 100A is shown as including a user experience testing system 150 that is in communications with data processing units 120, 190 and 195. Data processing units 120, 190 and 195 may be a personal computer equipped with a monitor, a handheld device such as a tablet PC, an electronic notebook, a wearable device such as a cell phone, or a smart phone.

Data processing unit 120 includes a browser 122 that enables a user (e.g., user experience test participant) using the data processing unit 120 to access target web site 110. Data processing unit 120 includes, in part, an input device such as a keyboard 125 or a mouse 126, and a participant browser 122. In one embodiment, data processing unit 120 may insert a virtual tracking code to target web site 110 in real-time while the target web site is being downloaded to the data processing unit 120. The virtual tracking code may be a proprietary JavaScript code, whereby the run-time data processing unit interprets the code for execution. In other embodiments, browser native APIs may be leveraged to collect data regarding the participant's sessions. In some embodiments, the browser native APIs and the virtual tracking code may be leveraged in combination to collect a full suite of information regarding the participant's activity. The tracking code collects participants' activities on the downloaded web page such as the number of clicks, key strokes, keywords, scrolls, time on tasks, and the like over a period of time. Data processing unit 120 simulates the operations performed by the tracking code and is in communication with user experience testing system 150 via a communication link 135. Communication link 135 may include a local area network, a metropolitan area network, and a wide area network. Such a communication link may be established through a physical wire or wirelessly. For example, the communication link may be established using an Internet protocol such as the TCP/IP protocol.

Activities of the participants associated with target web site 110 are collected and sent to user experience testing system 150 via communication link 135. In one embodiment, data processing unit 120 may instruct a participant to perform predefined tasks on the downloaded web site during a user experience test session, in which the participant evaluates the web site based on a series of user experience tests. The virtual tracking code (e.g., a proprietary JavaScript) may record the participant's responses (such as the number of mouse clicks) and the time spent in performing the predefined tasks. Screenshots, video and/or audio recordings, interactions with a specific interface, and touch data may also be collected based upon the study criteria. The user experience testing may also include gathering performance data of the target web site such as the ease of use, the connection speed, the satisfaction of the user experience. Because the web page is not modified on the original web site, but on the downloaded version in the participant data processing unit, the user experience can be tested on any web sites including competitions' web sites.

Data collected by data processing unit 120 may be sent to the user experience testing system 150 via communication link 135. In an embodiment, user experience testing system 150 is further accessible by a client via a client browser 170 running on data processing unit 190. User experience testing system 150 is further accessible by user experience researcher browser 180 running on data processing unit 195. Client browser 170 is shown as being in communications with user experience testing system 150 via communication link 175. User experience research browser 180 is shown as being in communications with user experience testing system 150 via communications link 185. A client and/or user experience researcher may design one or more sets of questionnaires for screening participants and for testing the user experience of a web site. User experience testing system 150 is described in detail below.

FIG. 1B is a simplified block diagram of a user testing platform 100B according to another embodiment of the present invention. Platform 100B is shown as including a target web site 110 being tested by one or more participants using a standard web browser 122 running on data processing unit 120 equipped with a display. Participants may communicate with a user experience test system 150 via a communication link 135. User experience test system 150 may communicate with a client browser 170 running on a data processing unit 190. Likewise, user experience test system 150 may communicate with user experience researcher browser running on data processing unit 195. Although a data processing unit is illustrated, one of skill in the art will appreciate that data processing unit 120 may include a configuration of multiple single-core or multi-core processors configured to process instructions, collect user experience test data (e.g., number of clicks, mouse movements, time spent on each web page, connection speed, and the like), store and transmit the collected data to the user experience testing system, and display graphical information to a participant via an input/output device (not shown).

FIG. 1C is a simplified block diagram of a user testing platform 100C according to yet another embodiment of the present invention. Platform 100C is shown as including a target web site 130 being tested by one or more participants using a standard web browser 122 running on data processing unit 120 having a display. The target web site 130 is shown as including a tracking program code configured to track actions and responses of participants and send the tracked actions/responses back to the participant's data processing unit 120 through a communication link 115. Communication link 115 may be computer network, a virtual private network, a local area network, a metropolitan area network, a wide area network, and the like. In one embodiment, the tracking program is a JavaScript configured to run tasks related to user experience testing and sending the test/study results back to participant's data processing unit for display. Such embodiments advantageously enable clients using client browser 170 as well as user experience researchers using user experience research browser 180 to design mockups or prototypes for user experience testing of variety of web site layouts. Data processing unit 120 may collect data associated with the user experience of the target web site and send the collected data to the user experience testing system 150 via a communication link 135.

In one exemplary embodiment, the testing of the target web site (page) may provide data such as ease of access through the Internet, its attractiveness, ease of navigation, the speed with which it enables a user to complete a transaction, and the like. In another exemplary embodiment, the testing of the target web site provides data such as duration of usage, the number of keystrokes, the user's profile, and the like. It is understood that testing of a web site in accordance with embodiments of the present invention can provide other data and user experience metrics. Information collected by the participant's data processing unit is uploaded to user experience testing system 150 via communication link 135 for storage and analysis.

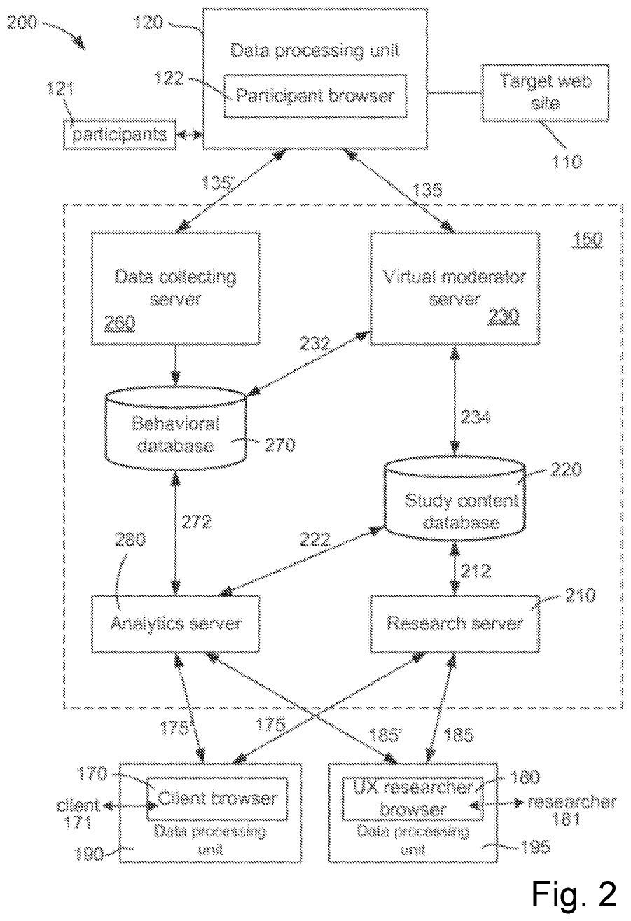

FIG. 2 is a simplified block diagram of an exemplary embodiment platform 200 according to one embodiment of the present invention. Platform 200 is shown as including, in part, a user experience testing system 150 being in communications with a data processing unit 125 via communications links 135 and 135′. Data processing unit 125 includes, in part, a participant browser 120 that enables a participant to access a target web site 110. Data processing unit 125 may be a personal computer, a handheld device, such as a cell phone, a smart phone or a tablet PC, or an electronic notebook. Data processing unit 125 may receive instructions and program codes from user experience testing system 150 and display predefined tasks to participants 120. The instructions and program codes may include a web-based application that instructs participant browser 122 to access the target web site 110. In one embodiment, a tracking code is inserted to the target web site 110 that is being downloaded to data processing unit 125. The tracking code may be a JavaScript code that collects participants' activities on the downloaded target web site such as the number of clicks, key strokes, movements of the mouse, keywords, scrolls, time on tasks and the like performed over a period of time.

Data processing unit 125 may send the collected data to user experience testing system 150 via communication link 135′ which may be a local area network, a metropolitan area network, a wide area network, and the like and enable user experience testing system 150 to establish communication with data processing unit 125 through a physical wire or wirelessly using a packet data protocol such as the TCP/IP protocol or a proprietary communication protocol.

User experience testing system 150 includes a virtual moderator software module running on a virtual moderator server 230 that conducts interactive user experience testing with a user experience test participant via data processing unit 125 and a research module running on a research server 210 that may be connected to a user research experience data processing unit 195. User experience researcher 181 may create tasks relevant to the user experience study of a target web site and provide the created tasks to the research server 210 via a communication link 185. One of the tasks may be a set of questions designed to classify participants into different categories or to prescreen participants. Another task may be, for example, a set of questions to rate the user experience of a target web site based on certain metrics such as ease of navigating the web site, connection speed, layout of the web page, ease of finding the products (e.g., the organization of product indexes). Yet another task may be a survey asking participants to press a “yes” or “no” button or write short comments about participants' experiences or familiarity with certain products and their satisfaction with the products. All these tasks can be stored in a study content database 220, which can be retrieved by the virtual moderator module running on virtual moderator server 230 to forward to participants 120. Research module running on research server 210 can also be accessed by a client (e.g., a sponsor of the user experience test) 171 who, like user experience researchers 181, can design her own questionnaires since the client has a personal interest to the target web site under study. Client 171 can work together with user experience researchers 181 to create tasks for user experience testing. In an embodiment, client 171 can modify tasks or lists of questions stored in the study content database 220. In another embodiment, client 171 can add or delete tasks or questionnaires in the study content database 220. In yet another embodiment, client 171 may be user experience researcher 181.

In some embodiment, one of the tasks may be open or closed card sorting studies for optimizing the architecture and layout of the target web site. Card sorting is a technique that shows how online users organize content in their own mind. In an open card sort, participants create their own names for the categories. In a closed card sort, participants are provided with a predetermined set of category names. Client 171 and/or user experience researcher 181 can create proprietary online card sorting tool that executes card sorting exercises over large groups of participants in a rapid and cost-effective manner. In an embodiment, the card sorting exercises may include up to 100 items to sort and up to 12 categories to group. One of the tasks may include categorization criteria such as asking participants questions “why do you group these items like this?.” Research module on research server 210 may combine card sorting exercises and online questionnaire tools for detailed taxonomy analysis. In an embodiment, the card sorting studies are compatible with SPSS applications.

In an embodiment, the card sorting studies can be assigned randomly to participant 120. User experience (UX) researcher 181 and/or client 171 may decide how many of those card sorting studies each participant is required to complete. For example, user experience researcher 181 may create a card sorting study within 12 tasks, group them in 4 groups of 3 tasks and manage that each participant just has to complete one task of each group.

After presenting the thus created tasks to participants 120 through virtual moderator module (running on virtual moderator serer 230) and communication link 135, the actions/responses of participants will be collected in a data collecting module running on a data collecting server 260 via a communication link 135′. In an embodiment, communication link 135′ may be a distributed computer network and share the same physical connection as communication link 135. This is, for example, the case where data collecting module 260 locates physically close to virtual moderator module 230, or if they share the user experience testing system's processing hardware. In the following description, software modules running on associated hardware platforms will have the same reference numerals as their associated hardware platform. For example, virtual moderator module will be assigned the same reference numeral as the virtual moderator server 230, and likewise data collecting module will have the same reference numeral as the data collecting server 260.

Data collecting module 260 may include a sample quality control module that screens and validates the received responses, and eliminates participants who provide incorrect responses, or do not belong to a predetermined profile, or do not qualify for the study. Data collecting module 260 may include a “binning” module that is configured to classify the validated responses and stores them into corresponding categories in a behavioral database 270.

Merely as an example, responses may include gathered web site interaction events such as clicks, keywords, URLs, scrolls, time on task, navigation to other web pages, and the like. In one embodiment, virtual moderator server 230 has access to behavioral database 270 and uses the content of the behavioral database to interactively interface with participants 120. Based on data stored in the behavioral database, virtual moderator server 230 may direct participants to other pages of the target web site and further collect their interaction inputs in order to improve the quantity and quality of the collected data and also encourage participants' engagement. In one embodiment, virtual moderator server may eliminate one or more participants based on data collected in the behavioral database. This is the case if the one or more participants provide inputs that fail to meet a predetermined profile.

User experience testing system 150 further includes an analytics module 280 that is configured to provide analytics and reporting to queries coming from client 171 or user experience (UX) researcher 181. In an embodiment, analytics module 280 is running on a dedicated analytics server that offloads data processing tasks from traditional servers. Analytics server 280 is purpose-built for analytics and reporting and can run queries from client 171 and/or user experience researcher 181 much faster (e.g., 100 times faster) than conventional server system, regardless of the number of clients making queries or the complexity of queries. The purpose-built analytics server 280 is designed for rapid query processing and ad hoc analytics and can deliver higher performance at lower cost, and, thus provides a competitive advantage in the field of user experience testing and reporting and allows a company such as UserZoom (or Xperience Consulting, SL) to get a jump start on its competitors.

In an embodiment, research module 210, virtual moderator module 230, data collecting module 260, and analytics server 280 are operated in respective dedicated servers to provide higher performance. Client (sponsor) 171 and/or user experience research 181 may receive user experience test reports by accessing analytics server 280 via respective links 175′ and/or 185′. Analytics server 280 may communicate with behavioral database via a two-way communication link 272.

In an embodiment, study content database 220 may include a hard disk storage or a disk array that is accessed via iSCSI or Fiber Channel over a storage area network. In an embodiment, the study content is provided to analytics server 280 via a link 222 so that analytics server 280 can retrieve the study content such as task descriptions, question texts, related answer texts, products by category, and the like, and generate together with the content of the behavioral database 270 comprehensive reports to client 171 and/or user experience researcher 181.

Shown in FIG. 2 is a connection 232 between virtual moderator server 230 and behavioral database 270. Behavioral database 270 can be a network attached storage server or a storage area network disk array that includes a two-way communication via link 232 with virtual moderator server 230. Behavioral database 270 is operative to support virtual moderator server 230 during the user experience testing session. For example, some questions or tasks are interactively presented to the participants based on data collected. It would be advantageous to the user experience researcher to set up specific questions that enhance the user experience testing if participants behave a certain way. If a participant decides to go to a certain web page during the study, the virtual moderator server 230 will pop up corresponding questions related to that page; and answers related to that page will be received and screened by data collecting server 260 and categorized in behavioral database server 270. In some embodiments, virtual moderator server 230 operates together with data stored in the behavioral database to proceed the next steps. Virtual moderator server, for example, may need to know whether a participant has successfully completed a task, or based on the data gathered in behavioral database 270, present another tasks to the participant.

Referring still to FIG. 2, client 171 and user experience researcher 181 may provide one or more sets of questions associated with a target web site to research server 210 via respective communication link 175 and 185. Research server 210 stores the provided sets of questions in a study content database 220 that may include a mass storage device, a hard disk storage or a disk array being in communication with research server 210 through a two-way interconnection link 212. The study content database may interface with virtual moderator server 230 through a communication link 234 and provides one or more sets of questions to participants via virtual moderator server 230. Participant communication and recruitment may involve push notifications, SMS messaging and postings to social media networks as well.

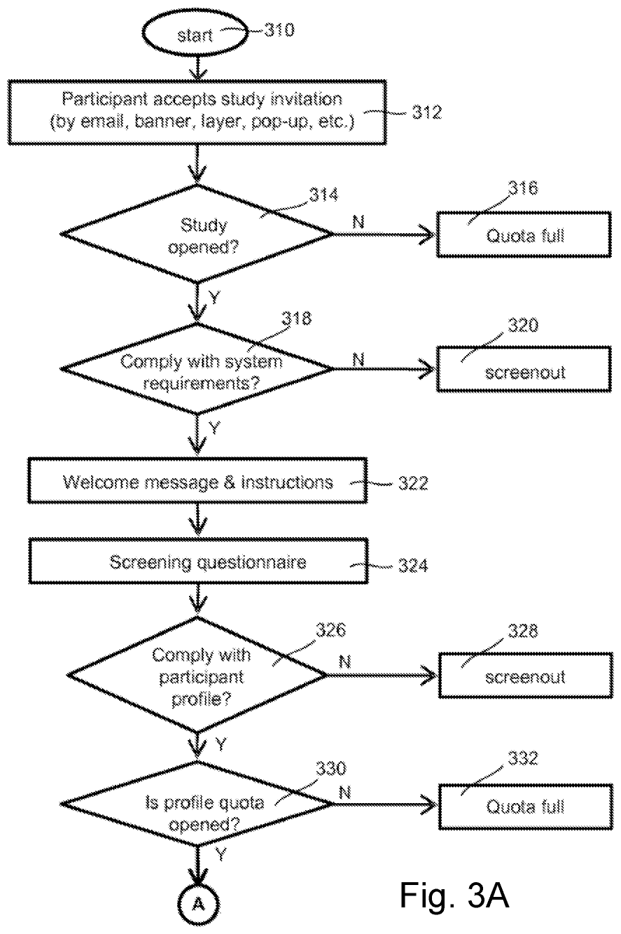

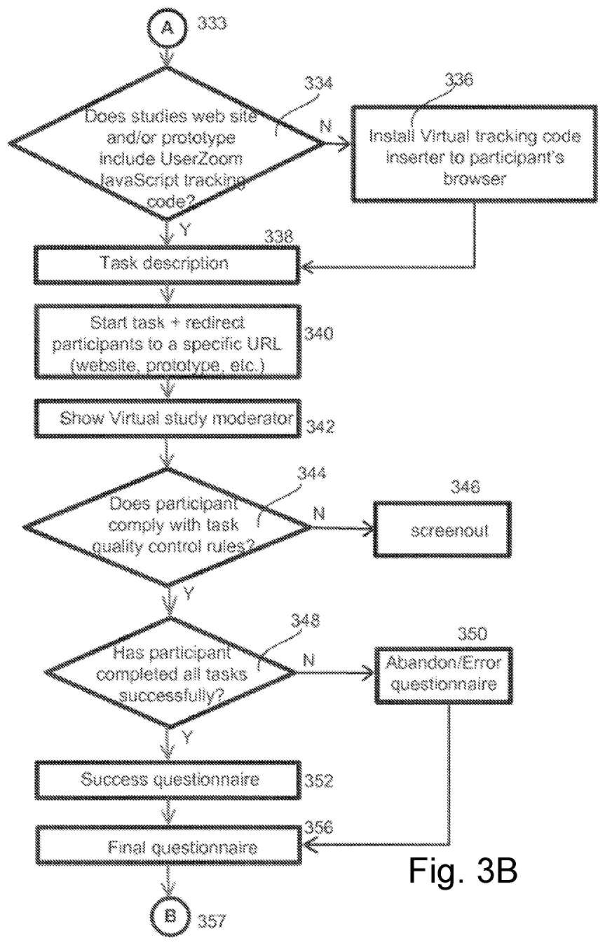

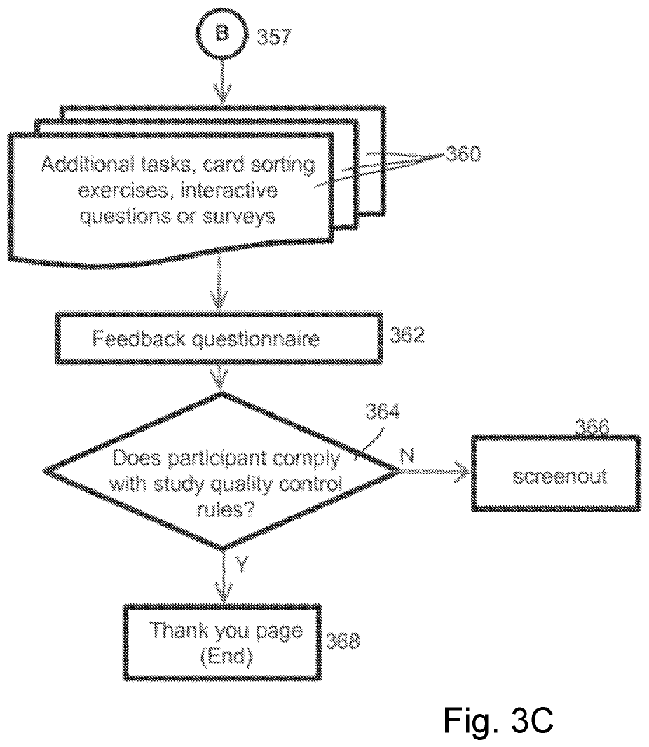

FIG. 3A is a flow diagram of an exemplary process of interfacing with potential candidates and prescreening participants for the user experience testing according to one embodiment of the present invention. The process starts at step 310. Initially, potential candidates for the user experience testing may be recruited by email, advertisement banners, pop-ups, text layers, overlays, and the like (step 312). The number of candidates who have accepted the invitation to the user experience test will be determined at step 314. If the number of candidates reaches a predetermined target number, then other candidates who have signed up late may be prompted with a message thanking for their interest and that they may be considered for a future survey (shown as “quota full” in step 316). At step 318, the user experience testing system further determines whether the participants' browser comply with a target web site browser, and whether the device, operating system, and peripherals meet the study requirements (e.g., a webcam of sufficient quality or a touch enabled device, for example). For example, user experience researchers or the client may want to study and measure a web site's user experience with regard to a specific web browser (e.g., Microsoft Edge) and reject all other browsers. Or in other cases, only the user experience data of a web site related to Opera or Chrome will be collected, and Microsoft Edge or FireFox will be rejected at step 320. At step 322, participants will be prompted with a welcome message and instructions are presented to participants that, for example, explain how the user experience testing will be performed, the rules to be followed, and the expected duration of the test, and the like. At step 324, one or more sets of screening questions may be presented to collect profile information of the participants. Questions may relate to participants' experience with certain products, their awareness with certain brand names, their gender, age, education level, income, online buying habits, and the like. At step 326, the system further eliminates participants based on the collected information data. For example, only participants who have used the products under study will be accepted or screened out (step 328). At step 330, a quota for participants having a target profile will be determined. For example, half of the participants must be female, and they must have online purchase experience or have purchased products online in recent years.

FIG. 3B is a flow diagram of an exemplary process for gathering user experience data of a target web site according to an embodiment of the present invention. At step 334, the target web site under test will be verified whether it includes a proprietary tracking code. In an embodiment, the tracking code is a UserZoom JavaScript code that pop-ups a series of tasks to the pre-screened participants. In other embodiments, browser native APIs may be leveraged to track participant activity (alone or in combination with the virtual tracking code). If the web site under study includes a proprietary tracking code (this corresponds to the scenario shown in FIG. 1C), then the process proceeds to step 338. Otherwise, a virtual tracking code will be inserted to participants' browser at step 336. This corresponds to the scenario described above in FIG. 1A.

The following process flow is best understood together with FIG. 2. At step 338, a task is described to participants. The task can be, for example, to ask participants to locate a color printer below a given price. At step 340, the task may redirect participants to a specific web site such as eBay, HP, or Amazon.com. The progress of each participant in performing the task is monitored by a virtual study moderator at step 342. At step 344, responses associated with the task are collected and verified against the task quality control rules. The step 344 may be performed by the data collecting module 260 described above and shown in FIG. 2. Data collecting module 260 ensures the quality of the received responses before storing them in a behavioral database 270 (FIG. 2). Behavioral database 270 may include data that the client and/or user experience researcher want to determine such as how many web pages a participant viewed before selecting a product, how long it took the participant to select the product and complete the purchase, how many mouse clicks and text entries were required to complete the purchase and the like. A number of participants may be screened out (step 346) during step 344 for non-complying with the task quality control rules and/or the number of participants may be required to go over a series of training provided by the virtual moderator module 230. At step 348, virtual moderator module 230 determines whether or not participants have completed all tasks successfully. If all tasks are completed successfully (e.g., participants were able to find a web page that contains the color printer under the given price), virtual moderator module 230 will prompt a success questionnaire to participants at step 352. If not, then virtual moderator module 230 will prompt an abandon or error questionnaire to participants who did not complete all tasks successfully to find out the causes that lead to the incompletion. Whether participants have completed all task successfully or not, they will be prompted a final questionnaire at step 356.

FIG. 3C is a flow diagram of an exemplary process for card sorting studies according to one embodiment of the present invention. At step 360, participants may be prompted with additional tasks such as card sorting exercises. Card sorting is a powerful technique for assessing how participants or visitors of a target web site group related concepts together based on the degree of similarity or a number of shared characteristics. Card sorting exercises may be time consuming. In an embodiment, participants will not be prompted all tasks but only a random number of tasks for the card sorting exercise. For example, a card sorting study is created within 12 tasks that is grouped in 6 groups of 2 tasks. Each participant just needs to complete one task of each group. It should be appreciated to one person of skill in the art that many variations, modifications, and alternatives are possible to randomize the card sorting exercise to save time and cost. Once the card sorting exercises are completed, participants are prompted with a questionnaire for feedback at step 362. The feedback questionnaire may include one or more survey questions such as a subjective rating of target web site attractiveness, how easy the product can be used, features that participants like or dislike, whether participants would recommend the products to others, and the like. At step 364, the results of the card sorting exercises will be analyzed against a set of quality control rules, and the qualified results will be stored in the behavioral database 270. In an embodiment, the analyze of the result of the card sorting exercise is performed by a dedicated analytics server 280 that provides much higher performance than general-purpose servers to provide higher satisfaction to clients. If participants complete all tasks successfully, then the process proceeds to step 368, where all participants will be thanked for their time and/or any reward may be paid out. Else, if participants do not comply or cannot complete the tasks successfully, the process proceeds to step 366 that eliminates the non-compliant participants.

Another user experience test that is commonly performed is a ‘click test’ study. In such a study the participant is provided a task or a prompt. The location and timing of the participant's mouse clicks are recorded by the system. In some embodiments, the click test may be particularly helpful when analyzing prototypes of a user experience. For example, on a mock-up of a webpage, the participant may be prompted to select the button for purchasing a specific sweater. The location of the participant's mouse selection is recorded and may be aggregated with other participants' results. This may be utilized to generate heatmaps and other such analytics regarding where participants thought it was appropriate to select.

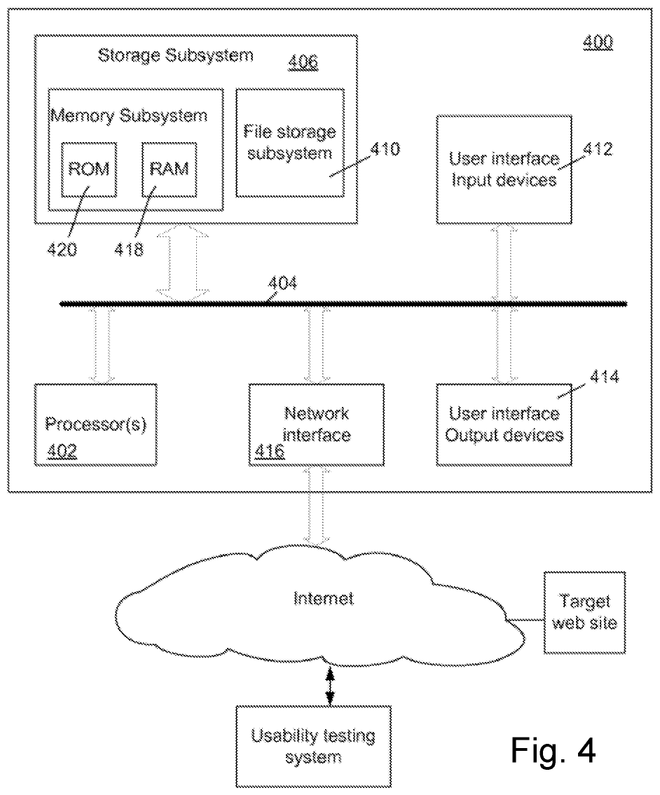

FIG. 4 illustrates an example of a suitable data processing unit 400 configured to connect to a target web site, display web pages, gather participant's responses related to the displayed web pages, interface with a user experience testing system, and perform other tasks according to an embodiment of the present invention. System 400 is shown as including at least one processor 402, which communicates with a number of peripheral devices via a bus subsystem 404. These peripheral devices may include a storage subsystem 406, including, in part, a memory subsystem 408 and a file storage subsystem 410, user interface input devices 412, user interface output devices 414, and a network interface subsystem 416 that may include a wireless communication port. The input and output devices allow user interaction with data processing system 402. Bus system 404 may be any of a variety of bus architectures such as ISA bus, VESA bus, PCI bus and others. Bus subsystem 404 provides a mechanism for enabling the various components and subsystems of the processing device to communicate with each other. Although bus subsystem 404 is shown schematically as a single bus, alternative embodiments of the bus subsystem may utilize multiple busses.

User interface input devices 412 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term input device is intended to include all possible types of devices and ways to input information to processing device. User interface output devices 414 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term output device is intended to include all possible types of devices and ways to output information from the processing device.

Storage subsystem 406 may be configured to store the basic programming and data constructs that provide the functionality in accordance with embodiments of the present invention. For example, according to one embodiment of the present invention, software modules implementing the functionality of the present invention may be stored in storage subsystem 406. These software modules may be executed by processor(s) 402. Such software modules can include codes configured to access a target web site, codes configured to modify a downloaded copy of the target web site by inserting a tracking code, codes configured to display a list of predefined tasks to a participant, codes configured to gather participant's responses, and codes configured to cause participant to participate in card sorting exercises. Storage subsystem 406 may also include codes configured to transmit participant's responses to a user experience testing system.

Memory subsystem 408 may include a number of memories including a main random access memory (RAM) 418 for storage of instructions and data during program execution and a read only memory (ROM) 420 in which fixed instructions are stored. File storage subsystem 410 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

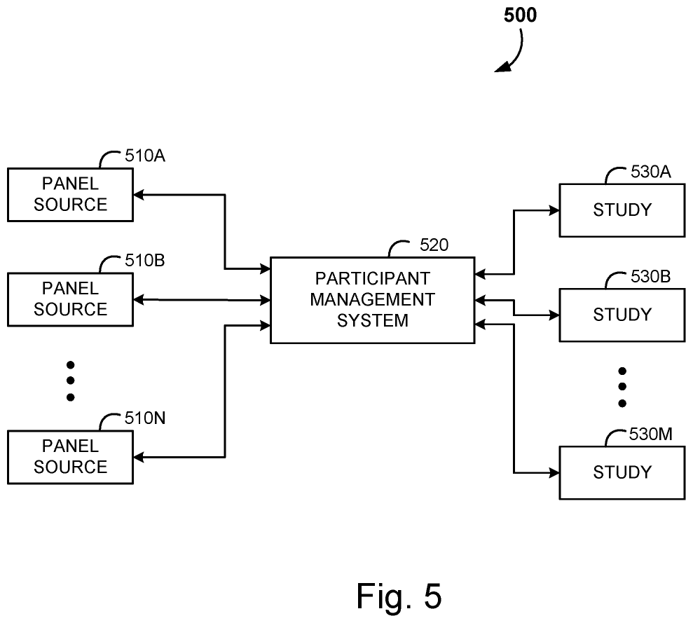

Now that systems and methods of user experience testing have been described at a high level, attention will be directed to the improved methods and systems employed for the selection of participants for these user experience studies. As noted, the outcome of these studies is entirely dependent upon having suitable participants. The most advanced UX testing platform is worthless without sufficient numbers of qualified participants to engage in the testing. FIG. 5 addresses this need for selection of qualified participants by presenting an example logical diagram of a participant selection architecture, shown generally at 500. Essentially this architecture includes a plurality of participant panel sources 510a-n, each interfacing with an intermediary participant management system 520. The participant management system 520 may include one or more servers operating at the same location as the aforementioned user experience testing system 150. In some alternate embodiments, the participant management system 520 may operate as a standalone system.

The participant management system 520 may communicate with the panel sources 510a-n via the internet or other suitable information transfer network. The participant management system 520 likewise interfaces with a user experience testing system 150 or with multiple independent UX experience systems, to receive studies 530a-m. Examples of study 530a-m requesters may include unified testing platforms such as UserZoom.

The studies 530a-m include information regarding the study scope, participant requirements, and in some embodiments the price the study is willing to expend upon the participants. Alternatively, the study may be assigned a pricing tier, indicating the level of service contract the study originator has entered into with the user experience testing platform.

The participant panel sources 510a-n likewise include information to the participant management system 520, such as total available participants on their platform, names or other identifiers for their participants, and collected known attributes for their participants. There are a few attributes that are almost universally collected by panel sources. These include participant gender and age, for example. However, other panel sources may collect additional panelist information beyond these most basic attributes. These other collected data points may include marital status, political affiliation, race, household income, interests, location, home ownership status, dietary restrictions/preferences, education levels, number of people in the household, and the like.

The participant management system 520 consumes the panelist information provided by the panel sources 510a-n and combines it with collected analytics for the potential participants. These potential participants are then initially filtered to exclude historically ineligible participants. The participant management system 520 then performs complex selection of participants from the panel sources for the studies 530a-m based upon participant cost/price, quality, time to field/speed, and availability concerns. This matching step includes considerations for study requirements, be they targetable attributes (known to the system) or non-targetable attributes (attributes which must be estimated for in the participant population). The process by which this selection occurs shall be discussed significant detail further below.

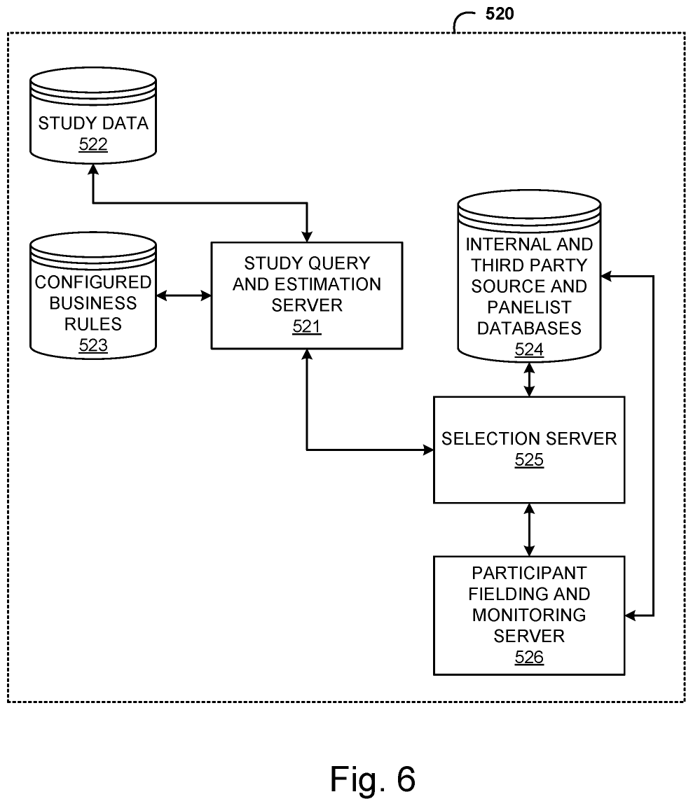

Turning to FIG. 6, a logical diagram of the participant management system 520 is provided in greater detail. As noted before the studies 530a-m provide study requirements. These requirements, at a minimum, include the number of participants required, a timeframe they are needed, and some basic indication of the attributes required. For example, a study may require 100 participants who are female, ages 35-45, who purchase luxury brands for a study that needs to conclude in three weeks. These study parameters are stored in a study data repository 522.

In some embodiments, the study may also provide, in plain conversational text, what is needed from the participants. This may include particular attributes or qualities in the participant. Additionally, the study requirements may provide metrics such as what features are most important in the participants. In some cases, this may even include weights to particular participant “scores”. These scores may be, for example, for the time to first response, time to completion, time to qualification, ratio of studies completed, and evaluation from previous studies from the clients (feedback).

Additionally, the participant management system 520 may include a repository of preconfigured business rules 523. These rules may be supplied directly from the study provider, or may be generated automatically based upon the contractual obligations existing between the study provider and the participant management system 520 entity. For example, one study provider may enter into a contract whereby they pay flat fee for unlimited studies to be designed under 100 concurrent participants with a guaranteed participant field time of less than 30 days. The system may extrapolate out the rules as being no more than 100 fielded participants at any time, minimum cost per participant, minimum quality threshold, and fill rate/speed of participant sourcing less than 30 days. The system will therefore source participants that are above the needed quality threshold at the lowest price possible to meet the 30 day commitment. If more than 100 participants are needed, to the degree allowed by the 30 day commitment, the system will throttle participant sourcing to maintain a level less than 100 participants fielded at any given time. If it is not possible to meet the 30 day requirements and the less than 100 participant cap, then the system will reject the most recent study, and suggest a contract upgrade to a larger participant number. In some embodiments, a client of the user experience testing may engage in an unlimited recruitment plan which could be utilized to provide unlimited participant samples if the requirements for the participants meets certain requirements (e.g., no more than X number of attributes are required, etc.) and under certain platform's feature usage limitations (e.g., the platform can only collect data for a maximum number of studies in parallel/concurrently). If these requirements are surpassed, the client could be offered an upgraded plan, or may pay on demand (ad hoc service) for the participant sampling outside of the unlimited sampling limitations.

As can be seen, the preconfigured business rules 523 have a significant impact upon how the system selects the participants, speed of participant sourcing, and which criteria may exclude possible participant sub-populations. This rule data 523 along with the study data 522 defining the study parameters are supplied to a study query and estimation server 521. This server 521 uses the constraints to determine which populations of participants are likely available given the information regarding the numbers and types of participants available collected from the panel sources 510a-n. This includes the number and unique identifier information for their potential participants, and well as any collected attribute information for them. The system over time is capable of augmenting this dataset with recoded quality metrics and score data for participants, the likelihood of them engaging with specific studies, discovered attributes, and imputed attributes. Discovered attributes include attributes for which the participant provides direct feedback regarding, whereas imputed attributes are predictions of attributed based upon correlation models. These correlation models may be rule driven, or may be generated using known machine learning techniques. An example of an imputed attribute such models may generate is that individuals who are known to have an income above $175,000 (known attribute) are likely to be consumers of luxury goods (imputed attribute).

In addition to determining the sample availability, the study query and estimation server 521 is likewise tasked with determining the pricing and estimated time in field. As noted before, sometimes these criteria are predetermined by a service level contract. In such flat-fee structures the system defaults to the lowest price possible to deliver the other required criteria. However, when one or more of these criteria are not dictated by the business rules, the study query and estimation server 521 can generate the expected cost and or speed of the participant sourcing based upon the known source data. In situations where the sourcing engine does not have access to suitable panel sources on hand, the system may auto-connect specialized sourcing panel vendors (for example a country specific sourcing vendor).

In some situations the study query and estimation server 521 will determine that a study, as proposed, is not feasible commercially. In such situations the study query and estimation server 521 may flag the study request with an error and propose alternate study requirements. For example, the cost, speed, quality and number/availability of individuals are interrelated. For a given quality threshold, the speed, cost and number can be modeled as a topographical surface chart. If a study client wants to increase the speed of participant sourcing, either the number needs to reduce, cost increase, or some combination of the two. Very fast and large study groups will be very expensive to field. Proper selection of participants may reduce these costs, allowing for faster and larger (or more exacting in the participant requirements) studies.

As noted, for some study criteria, it may simply be impossible (commercially or physically) to meet the required participant sourcing. In the case of a physical impossibility, the system will respond with a simple error and request for the criteria to be adjusted. Going back to the above example, if a study author wants to survey 10,000 participants with the afore mentioned computer programming experience, in two weeks, it is likely not physically possible to source that study, regardless of the price the study author is willing to pay. In the case of a commercial impossibility, the system will still throw an error, but will also propose an adjustment that enables the study to move forward. For example, assume the study author wants 100 computer programmers to engage in a two week study, but is on a basic flat-fee service contract. To fulfill the participant request, the query and estimation server 521 determines the cost of such a study is well outside of a threshold cost assumed for this basic service contract. The study author may then be proposed to either extend the study length by three additional weeks, or to upgrade their service contract to a premium level (thereby allowing for higher priced participants to be sourced).

Returning to FIG. 6, after the availability, price and time in field are all determined (or estimated) the selection server 525 performs the task of procuring the participants from the panel sources 510a-n. The selection server 525 utilizes information secured directly from the panel sources, as well as discovered and imputed data regarding the participants, which are all stored in the source and panelist database 524.

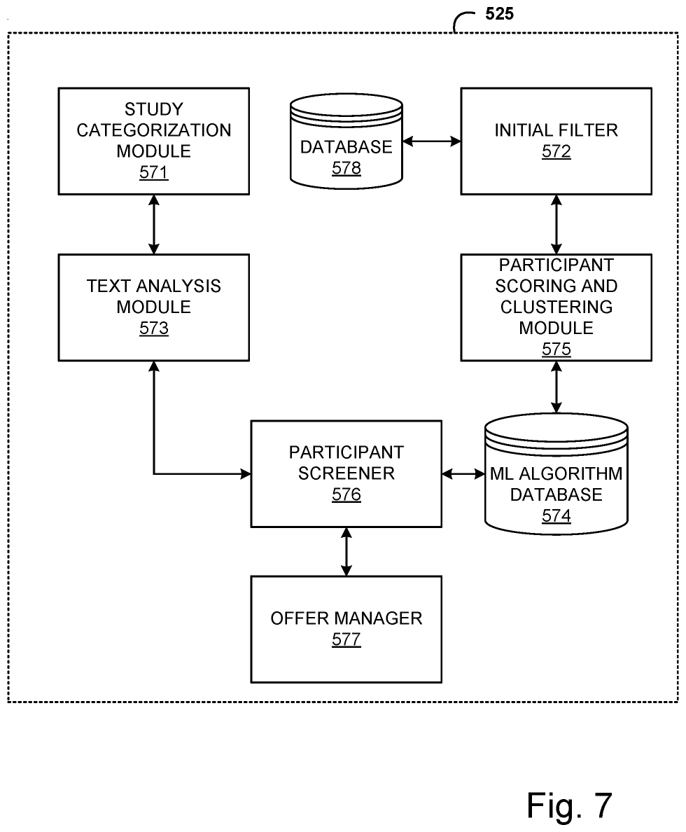

FIG. 7 provides a more detailed view of the components of the selection server 525. In some embodiment, the selection server includes sophisticated machine learning (ML) capabilities for the classification of studies, as well as the characterization and selection of participants. For example. The selection server 525 may include a study categorization module 571 which consumes the study requirements, as previously discussed. The categorization module parses the study requirements and determines which requirements are threshold participant criteria, advanced criteria, and the score weights of the study.

In some embodiments, the threshold participant criteria may be selected from the requirements by comparing the requirement type to classes of requirements. These classes of requirements are known for a majority of the participants in a dataset. For example, the gender of the participants is already known for the majority of participants. Race, income, and age are also characteristics that are either readily known or may be easily imputed. For example, a requirement for ‘female participants’ is compared to a conceptual ontological database to identify that this requirement applies to the class of ‘gender’. This class is compared against a listing of classes that constitute fundamental ‘threshold’ criteria. Threshold requirements are employed in an initial screening/filtering process that will be described in greater detail below.

The study characterization module 571 likewise parses out discrete requirements that do not fit into the threshold requirements, but are plainly defined. These may include attributes for the participants that are not likely to be already known, and will require additional screening to determine. Examples of these requirements may include things such as occupation, military status, family status and the like.

Likewise, weights or requirements for the various participant metrics may be collected for the given study. For example, the study may weight the time to completion more heavily than the time to qualification when overall speed of the study is of interest. Another study, however, may require that qualification occurs under a threshold time due to the characteristics of the study requirements (e.g., only a very narrow cohort of the participant population will qualify for the study, so it is important to weed out participants quickly, for example). In circumstances where weight or threshold values for the metrics/scores are not provided, a default weighting scheme may be employed. In some embodiments, the weights may be equal across all scores.

The last information about the study that the study categorization module 571 may receive is a free text explanation of what is desired in the participant pool. Such a free for text may express itself in the following manner: “I want 50 people, with an income of over $100k, with kids, and I need the study done in two weeks.” The free form text may be provided to the text analysis module 573. This module may employ known text recognition software to parse the text, perform normalization, lemmatization of the resulting normalized text, tokenization, and conceptual clustering. After these known text analysis techniques have been employed, the resulting tokenized context clusters are fed into a machine learning model (retrieved from the ML algorithm database 574) which determines the following: 1) size of the study, 2) classes of interest, and 3) score weights and/or requirements. For the above example, the analysis of the text would yield the following <Size=50>, <Classes=income; family_status>, <weight=time_to_completion>.

The class listing and the score weights are then compared to a full listing of classes and scores. For each that are not applicable, a null value is provided. In some embodiments there are five scores, as previously identified. In some embodiments, there may be many tens to thousands of classes. For each class that is not identified as a null value, a question is then generated. The question may be selected from a template. Each class may be associated with one or more templates. For example, income and age may have the template of “Is your <class><function><value>?” For the above example, the class here would be ‘income’, the function is ‘greater than’ and the value would be ‘$100,000’. Other classes may be more complex and include a number of applicable templates. For example, the class “car” may include the following templates: “Is your <class><function><value>?”, “Do you plan to purchase <class> in <value>?” and “Do you <emotion><class>?”. The template chosen is based upon the ML contextual analysis of the text requirements from the study administrator.

In situations where the text analysis has a confidence below a set threshold, a human operator may be required to intervene to assist in selecting the correct class, template and values/inputs into the given template. This information is then used to further train the machine learning models used to perform these activities. Likewise, if there are contextual text chunks that appear to not fit any class, the system may likewise flag these for human intervention. Since the requirements are free-form text, some study administrators tend to include “extra” or superfluous information. For example, a study administrator may write “Thanks for helping. I really have trouble making these studies. I need one with 100 people who like dogs. Can you help?” In this study requirements text, there are only two relevant portions of information: 1)<size=100>, and 2) <class=dog>. The remaining textual data will not be assigned to the size, class or score weightings. However, since there is so much additional text, it is beneficial for a human operator to ensure that important information is not being missed. If there is, then the system may be trained on the human's inputs. Likewise, if there are duplicate entries to any field, the system may also request human intervention to determine which class, value, or other input the study administrator is meaning. For example, an entry of “I want people who love/hate cats” would pose a significant issue to the ML model and likely would require human intervention in formulating the correct question.

As noted, the text analysis module 573 generates two outputs: 1) additional screener questions, and 2) discrete study requirements. These, along with the outputs from the study categorization module 571 are fed into the initial filter 572, which leverages data from database 578 to remove participants from the pools that are known to not meet the threshold requirements, basic quality standards, fraudulent participants, and duplicate records. For example, there is no reason to consider a male participant when the study is focused entirely on females. Likewise, a study of participants between the ages of 20-40 may discard a 50-year-old participant. These threshold requirements are known for most participants and are thus able to rapidly narrow the pool of potential participants to consider.

Fraudulent participants may be identified by their past performance. For example the speed taken by the participant and/or answer patterns may be used to identify participants who are not engaged, and are merely filling out studies for the reward. Generally these participants answer questions too quickly to be actually reading them (a time threshold based indicator of fraudulent participation), or the answers occur on a regular pattern (repeat pattern or continual selection of the first answer, for example). Another method of fraud detection may rely upon facial recognition to screen out duplicate participants, and to validate sociodemographic data supplied by the participants, such as gender, ethnicity, age, etc. In addition to being useful for fraud detection, facial recognition with known sentiment analysis (in addition to sentiment analysis of audio or text inputs) may be leveraged to collect non-biased feedback when using a product or engaging in the study. This feedback may be deemed a higher quality than participant supplied answers. Other possible pre-study participant monitoring for fraud detection may include checking the device for duplicates (utilizing MAC address for example), detection of bots by response speed or by challenge-response style questions, IP addresses from unsupported countries or the usage of illicit tools on the device.

After initial filtering of the participant pool(s), the remaining participants are provided to the participant scoring module 575 for generating metrics (scores) for each of the participants for selection and pruning purposes. Scoring includes clustering of participants, and then based upon model type and geography, the clusters are then sourced, according to suitability identified in the lookup table.

After participant scoring/clustering, the participants may be analyzed by a participant screener 576 which further narrows the participant pool. In some embodiments the participant screener 576 may apply screening questions to participants that have been randomly (or pseudo randomly) selected from the given participant clusters.

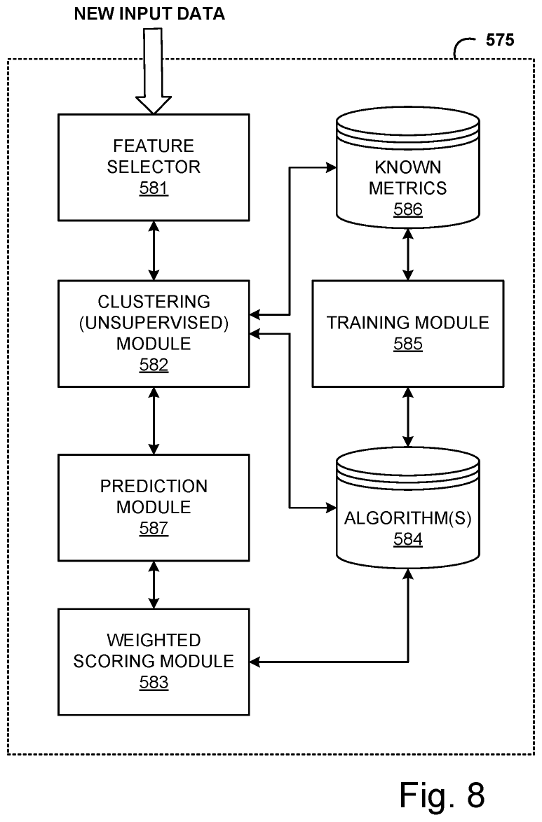

FIG. 8 provides a more detailed illustration of the participant scoring module 575. This system collects all of the known attributes (features) from the participant, and pairs them down to a listing of attributes that are determined to be of interest at a feature selection module 581. It is important to note that different participants have different backgrounds and may have entered the system in different ways. Some participants may have a significant online presence, allowing the system to glean significant amounts of attribute data for the participant. Other participants may have engaged in studies previously where they answered screening questions. The answers to the questions may be appended in the given participant's data file. In yet other instances, a particular pool of participants may have known traits/attributes/features. For example, A pool of participants generated by their visiting of Sports Illustrated website, for example, may all have the attribute of a ‘sports enthusiast’.

In some embodiments, the feature selection module 581 may have different listings of attributes/features, each listing associated with a different machine learning model. The model(s) are stored within an algorithm database 584.

Once the attributes/features are identified and collected (and where different ML models are used, the selection of the appropriate model), the features may be converted into scores. Outlying data may be first be removed. Scoring may be performed using quantile-based discretization. In quantile-based discretization the underlying feature data is divided up into bins/buckets based upon sample quantiles. In some cases these buckets are of equal size. The division of the feature data into the buckets maintains the original distribution but utilizes different scales (labels). The bins/buckets adjust to the nature of the data being processed. For example, 1000 values for 10 quantiles would produce a categorical object indicating quantile membership for each data point.

In some embodiments, raw scores are provided to the weighted scoring module 583 to generate a single score for each participant for each feature. The raw scores are first normalized before being combined. The singular score is based upon a weighted average of the normalized generated scores for the participant. The weights are collected from the study itself. When there are no scores provided, the system may utilize a default set of mathematical weights (for example, time to completion for a given study type may be weighted higher than the other study types). In some embodiments, the weights are equal, and the scores are combined by a simple average.

In some embodiments, instead of weights (or in addition to the weights) the study may provide mandated thresholds for the given score(s). For example, a study may require that any participant that are engaged completes their qualification within 3 minutes. In this example, participants with a score for time to qualification above the 3-minute mark may be automatically filtered out from the possible pool of participants for the study.

After scoring, the feature scores may be employed to generate clusters for the participant profiles using an unsupervised clustering algorithm. As noted before, the five features contemplated herein include 1) time to completion, 2) time to first response, 3) time to qualification, 4) ratio of studies completed, and 5) exclusions (collected from client feedback). This listing is of course non-exhaustive, as other qualities for the participants may also be leveraged by the clustering algorithm. Further, it should be noted, that in some embodiments only a subset of these scores may be utilized in the process for selecting the ‘best’ participants for a given study. In yet other embodiments, additional metrics may be employed, such as recency, frequency and engagement of the participant. In some embodiments, engagement is a function of time to response in light of the number of studies entered, as well as ratio of studies completed in light of grading feedback from the client. In some embodiments, deep-learning neural networks may be employed to cluster the selected features.

In some embodiments, additional screening questions are given to the various participants. These additional screening questions may be derived from the study requirements that have been directly provided to the system or may be questions that have been derived from the free-text input provided by the study administrators (as outlined above). Regardless of source, these questions may be presented after the participant pool has been selected based upon clusters. However, in some cases, there simply isn't enough feature data available to generate decent (of a confidence above a configured threshold) clusters. In these embodiments, it may be beneficial to ask the participants questions designed to collect the necessary attribute information. When asking for such attribute data, additional screening questions related to the requirements may likewise be asked even though the scoring of the participants has yet to occur (as the participant has been engaged at this stage anyway). Alternatively, the clustering may be supervised as opposed to unsupervised clustering.

The features used by the clustering algorithm are normalized/scored before consumption by the clustering algorithm. In some embodiments, the normalization may convert the raw feature data into a histogram/bucketize the data. The number of buckets the feature values are placed into is highly dependent upon the distribution of the feature values. For example, a prototypical normal distribution may lend itself to five equal sized buckets, whereas a skewed distribution may have fewer buckets. A distribution with two high-frequency peaks may only have two buckets even. Regardless of bucket number, each bucket may then be normalized to a particular value. This ensures that it is possible to meaningfully compare time to completion and ratio of studies completed (for example).

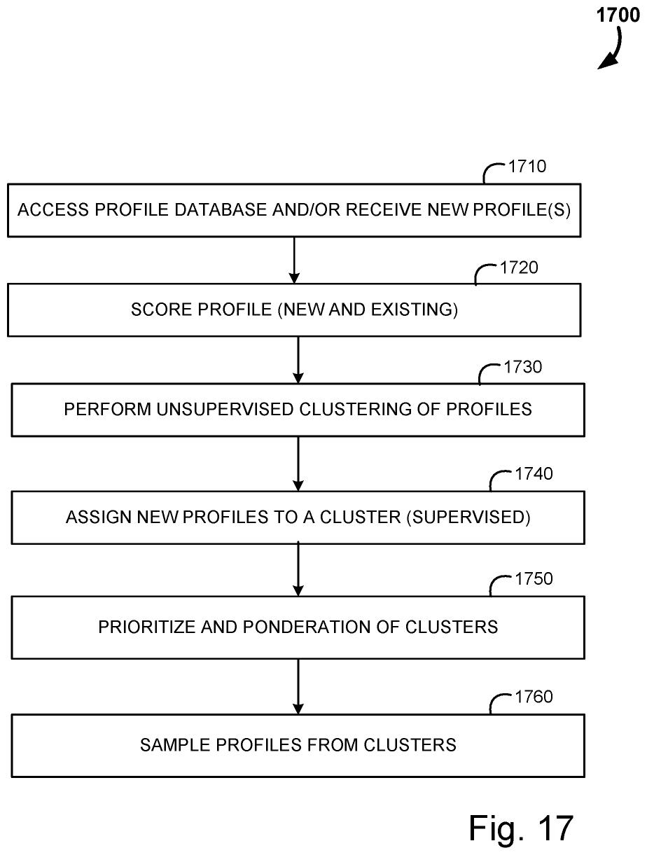

The machine learning model(s) that are being utilized in the unsupervised clustering module 582 and the prediction module 587 are generated by a training module 585, which utilizes a collection of known metrics for a given participant along with their sets of features, all stored in a known metrics database 586. For example, if a participant has engaged in a statistically significant number of studies, their scores may be measured, and trained using a deep learning technique (and other clustering techniques) to compare their known clusters to their features. In some embodiments, all features are tabulated, a vector set is defined for each participant for their features, and the vector sets are leveraged to train the model against the known clusters. In alternate embodiments, a clustering table may be employed, which will be disclosed in greater detail in relation to FIGS. 17-19.

In some embodiments the clustering is performed by k-means clustering, which measures the distance between all points and identifies a centroid. Each profile will belong to a single cluster per study type-country pair (one cluster per model).

In some embodiments, “statistically significant” or “substantially similar” may be based upon a calculated z-score and standard deviation of the various data inputs, and using these values computing a margin of error. This margin of error may be computed as a percentage of the absolute score and then compared against a threshold (e.g., 80, 90 or 95%). Other techniques, such as relying upon a confidence interval, or merely a standard deviation, may likewise be utilized to determine if sufficient study results have been collected for the given user in order to leverage them for a training set. In alternate embodiments, any participants whose scores are known may be leveraged to train the models. When participants are limited, this may be a preferred training mode.

Once the clusters for the participants have been generated by the clustering module 582, a prediction module 587 utilizes a lookup table (a profile cluster table) that indicates which cluster a profile/participant fits within based upon the geography/country of the participant and the model type (different models are utilized for different study types).

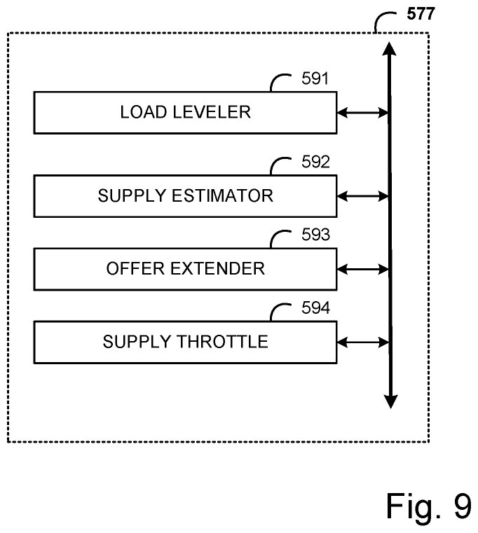

Once the cluster for the profile is ranked based upon geography and model (using the profile cluster table), and a set number of the highest ranked participants may be presented with an offer to join the study. In some embodiments, lower ranked participants may be included in some lower percentage. This ponderation with lower ranking participants is employed to avoid bias. In some embodiments, the set number of participants asked to join the study is based upon total study size, and difficulty of identifying a participant that meets all study requirements. In some embodiments, the number of participants asked to join a given study may change dynamically based upon a feedback loop. For example, if for the first 100 participants asked to join the study, only 10 qualify, the number of participants asked to meet a study size of 50 participants may be modified to invite 500 individuals. The offer manager 577 is responsible for the determination of how many offers to extend, and the sign-up of the participants. extension of these offers. FIG. 9 provides more detail of the offer manager 577.

A supply estimator 592 uses the study criteria to determine the likelihood of any one supplier to provide the needed number of participants. A targetable attribute predictor looks at study attributes which are targetable, and predicts the number of participants in the supplier pool that are likely to have these attributes. Targetable attributes include attributes for which the result is known or knowable. Age, gender, geography, national origin, county, household income, etc. are all considered targetable attributes. Some targetable attributes for the supplier's participants are known. As mentioned, for example, age and gender are generally known values across all panel suppliers 510a-n. Other targetable attributes are discovered through survey questions over time and are stored in the source and panelist database 524. For example, if a participant engages with a prior study in which their marital status is asked, this data may be stored in relation to the participant. Over time, the targetable attributes for a given participant may be expanded using patter recognition machine learning. For example, attributes like the participants preferred participation hours, prior screener responses, browsing and click patterns, etc., may all be collected and leveraged for targeting a particular participant for later studies.

For unknown targetable attributes, the targetable attribute predictor may use statistical techniques to determine the number of participants in the supply, to a certain confidence level, have the attribute. The targetable attribute predictor maps the supply population to the most granular population for which data is available, and extrapolate the attribute prevalence within the supply population. Outside sources, repositories and indicators may also be leveraged to collect information on targetable attributes for participants which are not know internally to the system.

For example, assume the targetable attribute of interest is for participants who are parents. Demographic information about birthrates and family status by age are known for state level geographic areas. A panel supply 510 based in the western United States consisting of participants predominantly between 20-30 years old, can have the prevalence for being a parent estimated by using this state and age demographic data. In this example, parental rates for this age bracket are below the general population level. Furthermore, for the states at issue, the trends are even lower. This mapping of the supply population to the most granular populations for which the attribute is known allows the targetable attribute predictor to more accurately determine the number of individuals in the supply populations that meet the targetable criteria.

In a similar vein, the non-targetable attribute estimator generates estimates for non-targetable attributes that are desired for the study in the supply populations. Non-targetable attributes are more ephemeral than targetable attributes. These are attributes that change (such as the participant having an ailment like the flu) or are attribute that are obscure and would not be commonly collected (such as how many 18th century French novels the individual owns, for example). Non-targetable attributes must be entirely estimated based upon incidents of the attribute in a given population (in much the same manner as targetable attribute estimations), but this is often not possible as, even in the aggregate, there is little information available regarding prevalence of these attributes. As such, the system generally begins a small scale sampling of the various populations, and subjecting these sampled individuals to questions to determine the frequency of the non-targetable attribute. Once statistically sufficient (e.g., seventy-fifth, eighty-fifty, ninetieth or ninety-fifth percentile confidence) data has been collected, then the estimate for the prevalence of the non-targetable attribute may be determined for the given supply. The statistical methodologies for sampling, and determining frequency within a larger population to a given confidence level are known in the field of statistical analysis, and as such will not be discussed in any exhaustive detail for the sake of brevity.

After the supply populations have thus been winnowed down to the total numbers of participants that likely exist that meet the study criteria, an invite number calculator is capable of determining how many individuals from each panel supplier 510a-n could conceivably be extended an invitation to join the study, subject to the initial filtering, and as ranked by their scores. Invitations may be active (e.g., a push notification or email) or passive (e.g., call to action in a study listing dashboard).

In the above manner the invite number calculator determines the capacities the panel sources 510a-n are realistically able to provide a given study. This process has been simplified as additional metrics, such as numbers of participants involved in alternate studies, closeness of attributes between these concurrent studies, and participant fatigue factors may likewise be included in the supply estimations. In particular, multiple overlapping studies may drain the availability of participants. This is especially true for studies for which the participant attributes overlap. Clustering algorithms, or least means squares functions may be utilized to define the degree of attribute overlap. This value can be used to weight (via a multiplication function) against study size to determine a factor of interference. This factor may be scaled based upon prior experience of the reduction in participant rates when multiple overlapping studies occur, and is used to reduce the estimates participant number (either by subtracting an absolute number of “tied up” participants, or via a weighing/multiplication of the estimated participant numbers by the scaled factor). Likewise, raw number of participants (or numbers modified by closeness of attributes as previously discussed) that occurred in the two, for or six weeks prior to the present study may be used to determine a “fatigue” reduction in participants. A few individuals will enjoy and endeavor to engage in one study after another. However, many individuals tire of responding to studies, and will throttle engagement in a cyclical manner. This fatigue factor may likewise be used to adjust the expected number of participants available, in some select embodiments.

An offer extended 593 may utilize the estimated capacities of the various suppliers to actually extend invitations to join the given study. This offer extension is always subject to the constraints and business rules discussed previously. For example, and panel supplier 510a-n that falls below a quality threshold may be excluded entirely from participating. In some embodiments, this quality cutoff threshold is determined by the same metrics discussed previously: too many of their participants answering earlier questions too quickly (or too slowly) and repeated answer patterns. Additional quality metrics may be compiled by manual audit of the participant's previous answers, or through the inclusion of normalization questions/red herring questions, or when a participant provides too few ‘clicks’ on a clicktest task. Generally fewer than five selections on a clicktest indicates a low quality participant. Normalization questions are questions asked repeatedly in the same way, or in different ways looking for consistency in answers. Likewise, red herring questions are simple questions that if not answered correctly indicates the participant is not actively engaged. Furthermore, a study author may rate the participant for quality as well. In some cases, the study author/client may determine that a participant is not suitable and may exclude the participant from engaging in any more of their studies.

Regardless of the metrics relied upon to collect quality measures, even when insufficient data is collected for any one participant, when the supplier as a whole is shown to have a quality issue not meeting the quality cutoff threshold, this supplier may be entirely discounted from the offer extension process.

Generally, after the threshold quality issue is determined, the offer extended 593 ranks the suppliers by price, and allocates the participant invitations to the suppliers in ascending order of their respective price/cost and calculated score. The tradeoff between study participant cost and their calculated score may vary based upon service level contract employed. A study administrator with a very high (and therefore costly) service level contract may receive the highest scored participants regardless of their respective costs, while a lower service level contract will look for a local optimization between score values and overall costs.

However, when two suppliers are substantially similar in cost and scores for their participants, then the system may alternatively determine the invite allocation by looking at the relative capacity of the various sources, and leveling the load imposed upon any given supplier. The load leveler 591 performs this tracking of participant demands being placed on any given panel supplier 510a-n and makes load leveling determinations by comparing these demands against total participants available in each supplier. For the purposes of this activity, “substantially similar” may mean less than either five, ten, or fifteen percent deviation in cost and scores (or some optimization between the two), based upon embodiment.

After invitations to join the study are sent to one or more of the panel suppliers 510a-n, the rate of acceptance can be monitored, and the number of invitations sent modified by a supply throttle 594. For example, if a lower cost and/or higher scoring set pf participants supplier ends up filling participant slots much faster than anticipated, then it is likely the estimates for the available participants was incorrect, and the total number of invitations may be ratcheted back. Additionally, it may be beneficial to batch release invitations in order to spread out study engagement. This allows the study systems to reduce spikes in computational demand, and further by extending study time to the limits of the service agreement with a client, the costs to the study provider can be more readily managed. Further, initial study results often times lead to changes in the study questions or objectives in order to explore specific insights more fully. By extending study invitation release, the throttle 594 allows time for such study updates to occur.

In addition to sending out invitations and collecting acceptances, the system may be configured to collect legal consent for the collection of personally identifiable information from the participants to satisfy various privacy laws (e.g., GDPR). This legal consent may be tailored for the particular study, for the specific study author/client more broadly, or for any future studies the participant chooses to engage in.

Returning to FIG. 6, after the selection server 525 sends out the initial invitations to the study the participant fielding and monitoring server 526 monitors the acceptance rates of the participants, as well as any data that is collected from screening questions regarding the participants. This data is stored in the source and panelist database 524, and the rates of invitation acceptance is particularly utilized by the supply throttle 594 as indicated previously. One additional feature of the participant fielding and monitoring server 526 is its ability to utilize known information about participants to port the participant data into the study administration system as a file, which allows the combining of source data with collected data. Thus, when different participant sources are utilized, where some information is known for some participants and not others, the file enables mapping of the known data to questions in the study. Thus, for example, participants whose household income is already known will not be presented with a study question relating to their income levels; only participants where this data is unknown will be required to answer such questions.

In addition to merely monitoring participants, before study start, and in order to improve participation quality, the system may implement an automatic training system for panelists to improve their skills to ‘think-out-loud’, how to provide feedback, what type of feedback is relevant for the client, etc. In general, people do not know how to talk out loud, naturally, while they interact with a digital interface. The training system makes them go through an automatic/self-serve learning flow and certifications.

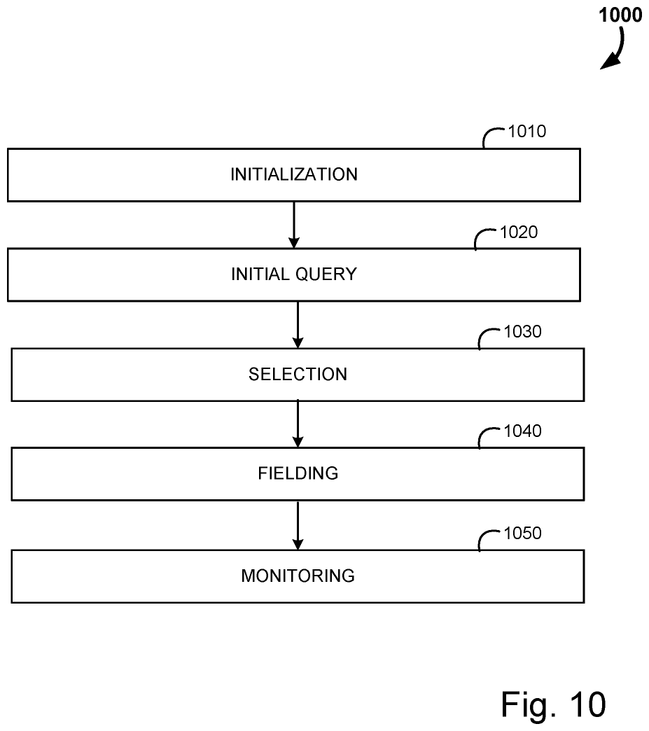

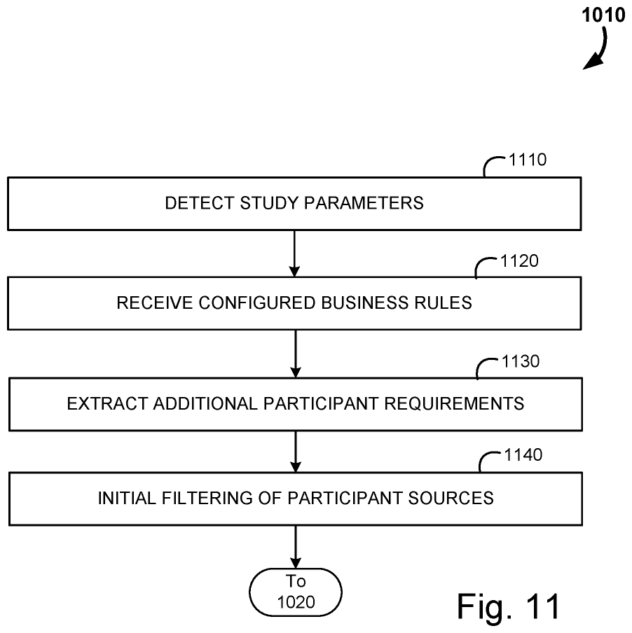

Now that the systems for intelligent participant sourcing have been described in detail, attention will be turned to example processes and methods executed by these systems. For example, FIG. 10 is a flow diagram for an example process 1000 of participant selection, in accordance with some embodiment. This example process begins with an initialization of the participant screening (at 1010). This initialization is shown in greater detail in relation to FIG. 11, where the study parameters are first detected (at 1110). These parameters include the length of the study estimations, demographic criteria/participant requirements, score weights and or thresholds, and study type. The business rules are likewise received (at 1120). These rules may have a default set of configurations, may be configured by the client directly, may be automatically generated leveraging machine learning, or in some embodiments, may be extrapolated from a service level agreement between the client and the participant sourcing entity. The system may also extract additional participant requirements (at 1130) when a study administrator provides a free-form text explanation of what they desire the study to accomplish.

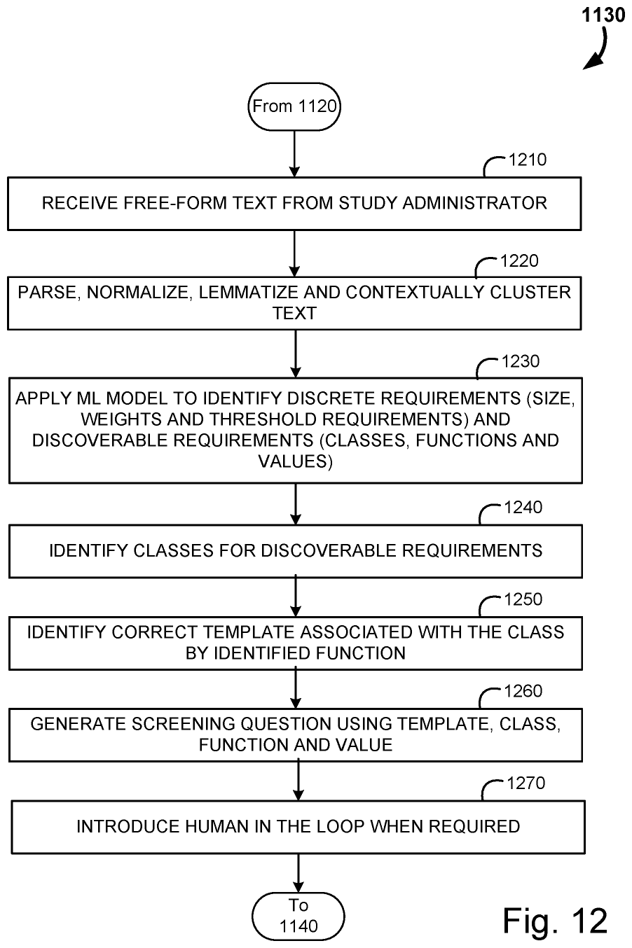

Study requirement extrapolation is provided in greater detail in relation to FIG. 12. In this process, the free-form description of what the study administrator desires is first received (at 1210). In some embodiments, the free-form description may be provided not as text, but rather as a video or audio file. In these cases the audio portion of the file is converted into text. The language of the text in subjected to known text processing techniques, including the parsing of the text into contiguous segments, normalization of the text, tokenization and lemmatization, and then contextual clustering in order to generate a meaning for the imputed language.

A machine learning model is applied to the context clusters to determine if the context applies to a discrete requirement (e.g., study size of 100, participant score of 0.7 or higher, score weights of XYZ, etc.) and discoverable requirements (at 1230). The discoverable requirements are generally defined by a requirement class, and some sort of function and a value. For example, the statement that “I want participants that are looking to buy a car in 6 months” would have a class of “car” a function of “time_to_buy” and a value of “<6 months”. These class features are identified (at 1240) using the ML model. A template is then selected for the question (at 1250). Generally, each class has a set of templates associated with it. Each template then has a function associated with it. By narrowing the templates by first class, and then by function, the correct template may be identified. The template is then populated using the class, function and value data (at 1260). Sometimes the ML confidence interval for the textual clustering and/or the identification of class, function and/or value are lower than an acceptable threshold. When this occurs, a human may be introduced into the loop for clarification and correct template selection. Likewise, if the free-form text supplied by the study administrator includes significant text that the models are unable to generate a contextual cluster for, a human may be asked to review the text to ensure nothing has been missed. The results from the human intervention may be fed back into the training of the models, thereby increasing model effectiveness in the future.

Retuning to FIG. 11, the participants are then filtered (at 11400) to remove duplicate participant records, to remove participants that have been found by the system to be fraudulent and/or below a basic quality threshold, and to remove participants for which attributes are known that do not meet the study requirements. Again, quality and fraudulency metrics for a participant may be gained through temporal tracking of prior participant activity, unusual answer patterns by the participant, or by specifically ‘testing’ the participants by red-herring style questions or questions that look for consistency in the participants answers. In addition to filtering out fraudulent participants when generating the panel, there may further be a fraud check when the participants selected for enter the study. These fraudulent individuals are generally “quarantined” to ensure they are removed from the dataset of eligible participants for all future studies. It is also possible to quarantine (permanent or temporarily) participants that have already participated in a study for a particular client from ever engaging in another study for that particular client.

After initialization in this manner, returning to FIG. 10, an initial query is made (at 1020). The initial query is when the participant management system 520 initially connects with the panel sources 510a-n to determine sample availability, pricing and estimated time in the field from the sources. While the participant management system 520 communicates regularly with the panel sources 510a-n, and thus has an indication of the participants available at each source, due to other commitments, membership changes, or contractual restrictions, the available number of participants, and pricing may vary from one study to the next. As such, prior to any panel selection activity, these items are ideally confirmed via the initial query with the various suppliers.

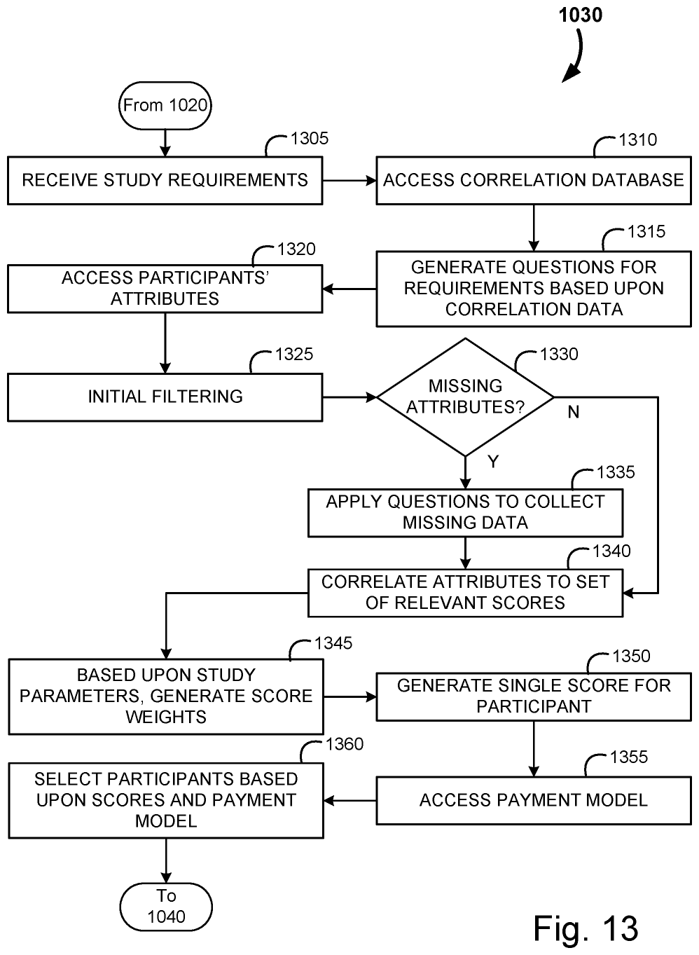

Subsequently, the selection of the participants is performed (at 1030). FIG. 13 provides a more detailed flow diagram of this selection process. The study requirements that have been received directly from the study administrator, or as parsed out from the free-form text input are first received (at 1305). The correlation database is accessed at (1310) and questions for the requirements are generated based upon the correlation of some attributes to the given requirements (at 1315). For example, if the study needs individuals that have a time to qualification under 3 minutes, and the system has correlated three attributes to estimate this metric, the system may generate questions regarding these attributes (from a selection of pre-generated questions associated with each attribute) in order to determine the desired metric.

The attributes/features that are already collected for the participants are then accessed (at 1320). The system may perform an initial filtering (at 1325) of the participants based upon “threshold attributes” which are known for most participants and are requirements for the study. Again, age, gender, income, and the like generally fall within this category of threshold characteristics. Likewise, when a participant has an attribute that is known already, that fits into the requirements of the study administrator (or the generated requirements for features), these participants may likewise be subjected to an initial filtering based upon these known features.

For the participants that survive the initial filtering, a determination is made if there are attributes that are required that are not yet within their file (at 1330). When such attributes are indeed missing, the system may first attempt to impute the missing attributes from known attributes by way of the correlation between attributes. For example, if the attribute that is desired is that the participant purchases diapers, and this attribute is unknown, but it is known that the family the participant belongs to has an infant, it may be imputed that the participant purchases diapers. In the attribute cannot be imputed with a high degree of confidence, the participant may be asked the necessary question(s) to collect the missing attribute information (at 1330). Once the needed attribute information has been collected, a second filtering of the participants for the attribute requirements may likewise be performed (not illustrated).

Once participants will all needed attributes have been identified and compiled, the attributes may be correlated to a set of relevant scores (at 1340). As noted previously, in some particular embodiment, the scores may include: 1) time to completion, 2) time to qualification, 3) time to first response, 4) ratio of studies completed and 5) evaluation from previous studies from clients (feedback). This listing is of course not exhaustive, and other relevant metrics may also be computed based upon the embodiment. Although not shown, participants with a score below a required threshold (set by the study administrator) may likewise be filtered out at this stage of the process (when applicable).

After the scores themselves have been generated, a set of weights for the various scores may be retrieved from the study requirements (when available) or a default set of weights may be leveraged (at 1345). In some embodiments, the weights are equal.

Using these numerical weights, a single score may be compiled for the set of metrics using a normalization of the metrics, and then a weighted average of them (at 1350). Payment models for the study administrator may also be accessed (at 1355) and the score and payment model may be leveraged to pick the final set of participants for extending the offer to (at 1360). In some embodiments, this selection is an optimization between a cost for the participant and the score. The cost and score are weighted in this optimization based upon the payment/pricing model the study administrator is subject to.

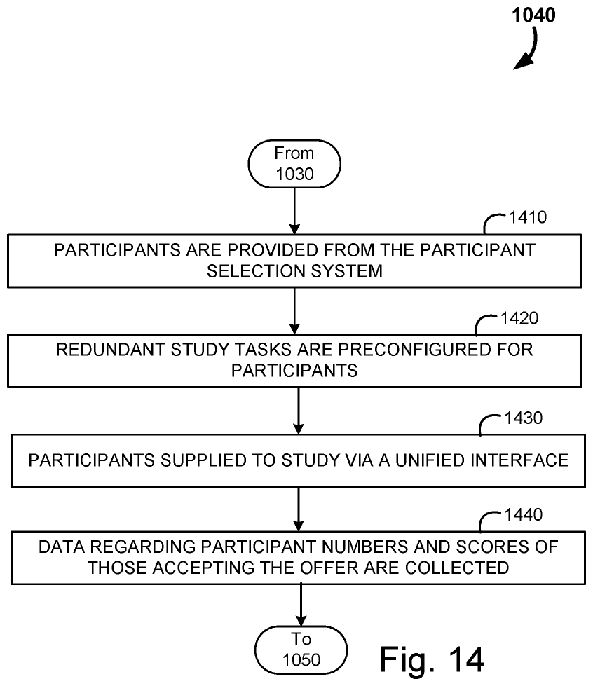

Returning to FIG. 10, after participant selection is thus completed (or on an ongoing basis as participants are joining), the participants are fielded (at 1040). FIG. 14 provides greater detail of this participant fielding process. Initially the participants are provided to the participant management system from the selection process (at 1410). A file is generated for each participant based upon data known by the panel source that is supplied, as well as data for the participant that has been previously discovered from an earlier study that the participant management system has stored. It is possible, based upon sources of the participants, and prior tasks by the participants, that each participant file may include differing degrees of information. This file is provided to the study administration server (user experience testing system), enabling questions and or tasks that are redundant (answers are already known for) to be preconfigured for the given participant (at 1420). This increases efficiencies for the study author, as well as reducing testing time for participants (reduced participant fatigue). Subsequently the participants are supplied to the study by the unified interface hosted by the user experience testing system (at 1430). As the participant engages in the study, data regarding participant targetable attributes, scoring, and numbers involved in the study are reported back to the participant management system (at 1440). This information is used to enrich the dataset regarding the participants for future studies, as well as assisting with participant sourcing throttling (as previously discussed).

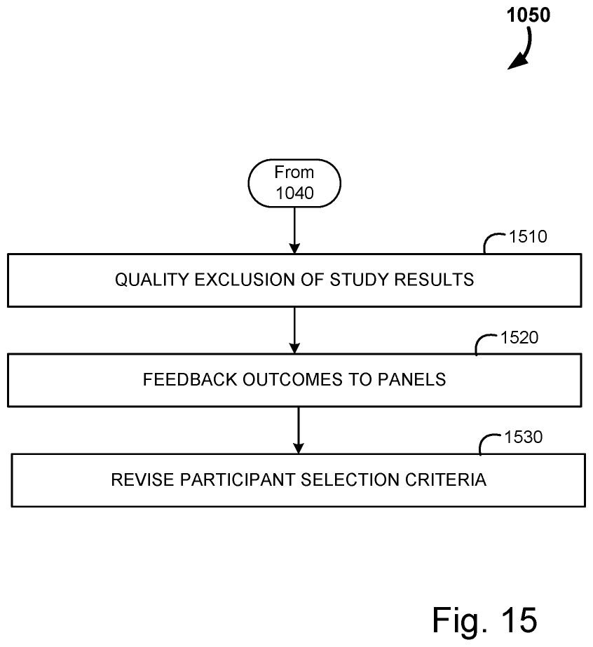

Returning to FIG. 10, the last step in the participant selection process is the monitoring of the resulting outcomes (at 1050). FIG. 15 provides greater detail into this monitoring process, whereby study results are filtered based upon quality exclusions (at 1510). Both the raw study outcome information, and those that have been filtered for quality, are feed back to the panel sources (at 1520). This feedback allows the separately operated panel sources to improve their own internal processes. In conjunction, the participant selection criteria can be revised (at 1530). For example, assume participants are willing to join the study, with higher scores and lower costs than expected. The participant management system would be able to dynamically react to these changing conditions by discontinuing sourcing of participants from more costly sources and instead switch to the lower cost sources. Once the participant quote is reached, the sources are signaled to stop sending participants to the participant management system. In addition to revising participant selection, the system may increase or reduce the panelist costs/payments based upon rate of participant acceptance of invitations versus the expected rates of acceptance.

In addition, revising participant selection may select, store and exploit historically monitored data to automatically generate or modify business rules to improve the study performance, optimize costs, and therefore improve the previous steps of this example process via cumulative feedback improvements. The historically monitored data may include, for example, response time, quality of results, invitations sent versus actual participation rates, desired completions of the study, and the like. The business rules that are generated or modified may include the frequency of invitation launches, quantity of the invitation launch, panel provider ranking, and the like.

In some embodiments, the system may leverage models that define the most cost-efficient incentives for participants to be able to complete studies as fast as possible with the maximum level of quality possible. Such models may determine incentive levels on a participant-by-participant basis and select between equally qualified participants based upon a cost minimization model. Additionally, incentive types and methodologies may be tailored for each participant. For example, one participant may be motivated by gamification techniques just as well as by monetary incentives (or reduced monetary incentives gained through a gamified system). Another participant may enjoy the ease of a credit (e.g., Amazon account credit) compared to a cash rebate. As such this participant may be able to be incentivized for a lower monetary value by leveraging their preferred channel. By this purposeful selection of participants, and the minimizing the incentives required to get the desired behavior from each participant, total study costs may be reduced substantially.

Lastly, usage is recorded for the purposes of billing customer and paying participant suppliers. This concludes this example process of sourcing participants for user experience studies.

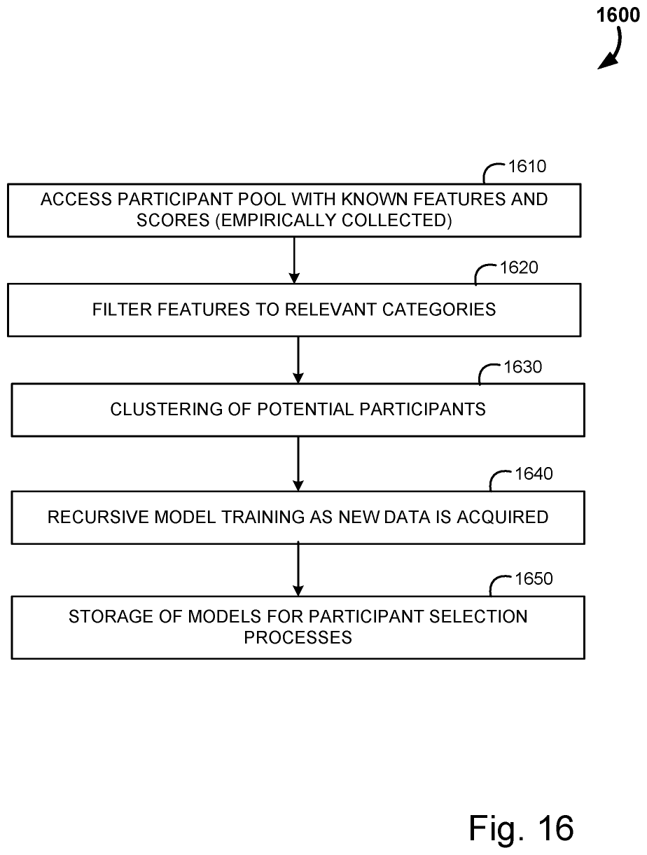

Lastly, FIG. 16 provides a flow diagram for the example process of model training, shown generally at 1600. The process starts with the collection of participants with a set of attributes and known scores that have been empirically collected (at 1610). The features can be then filtered into categories (at 1620). The full set of attributes are converted into a matrix, with each participant a row, and the features as columns. A vector set for the participant is then generated from the matrix, and the vector is input into a deep learning model (unsupervised clustering) model (at 1630) to generate clusters for the participants.

The models, once generated, are not static. They are iteratively trained, in the manner above, when new data becomes available (at 1640). The models are stored and leveraged for participant selection (at 1650) as previously discussed.

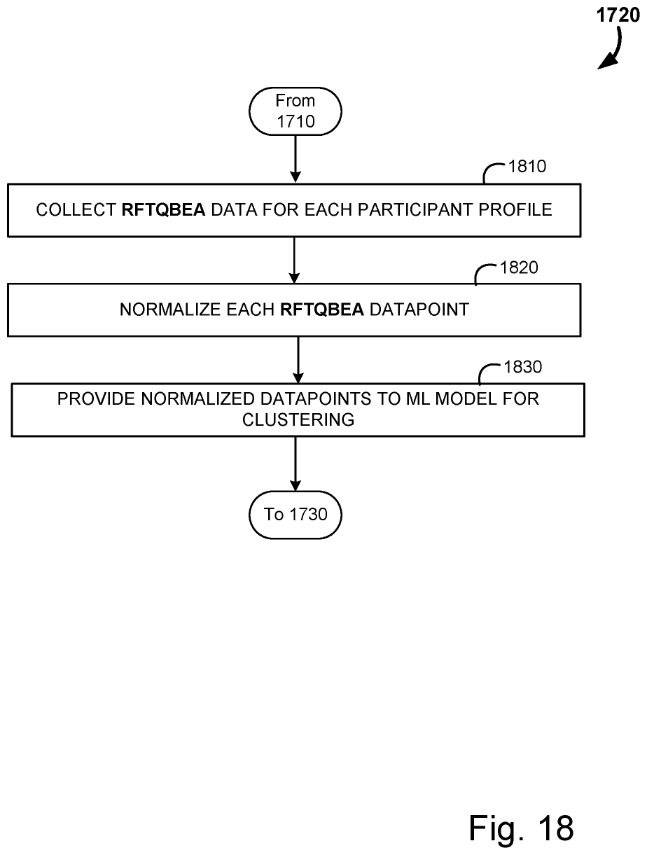

Turning now to FIG. 17, an alternate process for participant selection is provided, shown generally at 1700. In this process the profile database for participants is accessed (at 1710). Additionally, or alternatively, new profiles are received. New profiles generally have many features either missing entirely or containing very limited data. Both the new and existing profiles are scored (at 1720). FIG. 18 provides a more detailed process description of the scoring.

Initially, the RFTQBEA data is collected for each participant profile (at 1810). These categories refer to the time since last participation or Recency (R), the total number of participants of that profile/training period or Frequency (F), the time response score (T), quality response score (Q), the burnout ratio (B), an exclusion variable (E), and one or more miscellaneous attributes (A₁-Aₙ). The RFTQBEA data is then normalized using quantile-based discretization (at 1820). The normalized datapoints are then provided to a k-means ML clustering algorithm which generates the actual clusters for each profile per country and per study type (at 1830).

Returning to FIG. 17, after scoring the profiles, unsupervised clustering of the profiles is performed as previously discussed (at 1730) using unsupervised clustering models. The new profiles, however, may also be assigned to a cluster in a supervised manner (at 1740). In some embodiments, if there is not enough history for a profile to be clustered automatically, the supervised clustering aligns the profile with similarities in known profiles (even if these similarities are not leveraged in the clustering algorithms). The clusters are prioritized and ponderation of the clusters is performed (at 1750). Based upon where and what model/study type is being employed, the clusters are identified in the profile lookup table to determine the rank of the given clusters. Higher ranked clusters are sampled with a greater frequency than lower ranked clusters. Each cluster, based upon its RFTQBEA values has a given score. Each profile within the cluster is presumed to have the same score (expected generalization). Depending upon the scores, the sampling rates for the clusters may vary (at 1760). For example, if the highest ranked cluster has a score of 10, and the next highest ranked cluster score is 8, and the third highest ranked cluster is 3, then in this example 50% of participants could be sourced from the first cluster, and 40% and 10% for the second and third ranked clusters, respectively. However, if the scores were 10, 5 and 2, for example, the sourcing could be 75%, 20% and 5% respectively. The provided examples are purely for illustrative purposes, and do not necessarily reflect actual score and sampling frequencies. If any given cluster does not have sufficient numbers of participants in them, the following cluster in the same rank will be utilized to complete the quota requirements.

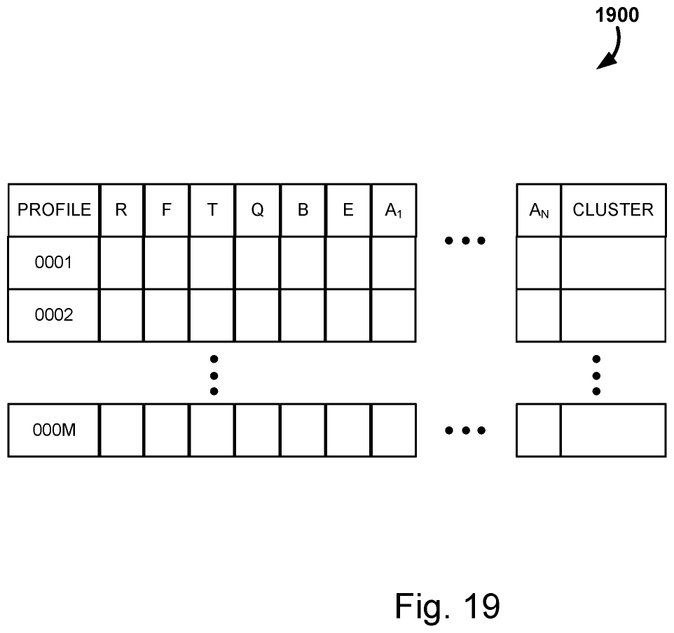

FIG. 19 provides an example illustration of a clustering table, shown generally at 1900. Each row on the table includes a different participant profile 1-m. The RFTQBE scores are in columns 1-6. One or more attributes are found in columns 7-n. Attributes may include demographic attributes, or any measurable features that are of relevance to determining a cluster for the given profile.

Some portions of the above detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for selecting participants for a user experience study comprising:
receiving at least three features for each participant profile;
scoring each participant profile by quantile-based discretization;
the grouping participants using an unsupervised machine learning (ML) clustering algorithm to generate a cluster from a plurality of clusters for each participant profile;
ranking the plurality of clusters based upon a model of a plurality of models, wherein each model of the plurality of models is a function of geography and study type; and
sampling participants from each cluster responsive to the ranking.

2. The method of claim 1, wherein the scores include: 1) time since last participation, 2) total number of participations of the given participant profile, 3) time response score, 4) quality response score, 5) burnout ratio, and 6) exclusion variable.

3. The method of claim 1, wherein each cluster has a single score for each model.

4. The method of claim 3, further comprising receiving a numerical weight for each of the scores.

5. The method of claim 4, wherein each participant profile is assigned to a single cluster for each model of the plurality of models.

6. The method of claim 4, wherein the sampling proportion from each cluster is correlated with the cluster score.

7. The method of claim 6, wherein the sampling includes ponderation from lower ranked clusters.

8. The method of claim 1, further comprising clustering new participant profiles using supervised modeling.

9. The method of claim 1, further comprising intentionally sending an invitation to the selected participants which are a better fit to engage in a user experience study.

10. The method of claim 1, further comprising asking the filtered participants at east one question to determine at least one missing feature.

11. A method for streamlining tailored screening questions for recruiting targeted participants for a user experience study comprising:
receiving an unstructured description of a recruiting sample requirements;
interpreting the unstructured description to relate the unstructured description to a concept;
extracting from each concept a subject relating to at least one sampling target;
correlating the subject to an attribute for the at least one sampling target; and
selecting a template question from a plurality of template questions for the attribute responsive to the subject.

12. The method of claim 11, wherein the subject includes a class, a function and a value.

13. The method of claim 12, wherein the determining the template includes filtering a plurality of templates by the class, and then selecting a template from the filtered templates using the function.

14. The method of claim 13, further comprising generating a question using the template, the class, the function and the value.

15. The method of claim 14, further comprising presenting the question to a subset of sample targets of the at least one sample target of a user experience test.

16. The method of claim 13, further comprising extracting a requirement from the generated question.

17. The method of claim 11, wherein the description includes at least one of text, audio and video.

18. The method of claim 11, wherein the interpreting includes parsing the unstructured description, normalizing the parsed description, lemmatizing the normalized description and conceptually clustering the lemmatized description.

19. The method of claim 11, wherein the correlating uses at least one ML model.

20. The method of claim 11, wherein the attribute is correlated with a score for a participant.
